(19) United States
(12) Patent Application Publication
(10) Pub. No.: US 2024/0172081 A1
(43) Pub. Date: May 23, 2024

(54) Data Buffer based Connection Reconfiguration Control

(71) Applicant: Telefonaktiebolaget LM Ericsson (publ), Stockholm (SE)

(72) Inventors: Mehdi Abad, Aachen (DE); Icaro Leonardo Da Silva, Solna (SE); Victor Farias Monteiro, Fortaleza (BR)

(21) Appl. No.: 18/549,209

(22) PCT Filed: Mar. 10, 2021
(86) PCT No.: PCT/EP2021/056057

§ 371 Date: Sep. 6, 2023

(51) Int. Cl. H04W 36/36; H04W 36/02; H04W 36/08

(52) U.S. Cl. CPC H04W 36/362; H04W 36/023; H04W 36/08

(57) ABSTRACT

A wireless communication device (10, 101-1, 101-2) monitors one or more conditions related to one or more data buffers for data to be transmitted on a wireless connection maintained by the wireless communication device (10, 101-1, 101-2). Based on the one or more conditions, the wireless communication device (10, 101-1, 101-2) controls timing of executing a reconfiguration of the wireless connection.

### TECHNICAL FIELD

The present invention relates to methods for controlling measurement reporting in a wireless communication network and to corresponding devices, systems, and computer programs.

### BACKGROUND

In wireless communication networks as for example specified by 3GPP (3^{rd} Generation Partnership Project), various procedures are used to control connectivity of a UE (user equipment) to the wireless communication network. One type of such procedure is a HO (handover), where a UE connected to a certain cell of the wireless communication network changes its connection to another cell, e.g., due to mobility of the UE and/or due to changing conditions. In the case of a HO, the cell the UE is initially connected to is typically referred to as source cell and the cell the UE is connected to after successful execution of the HO is typically referred to as target cell. A HO is typically controlled from the network side and for example initiated by sending a HO command to the UE. Other examples of procedures for controlling connectivity of a UE to the wireless communication network include control of carrier aggregation (CA) and control of dual connectivity (DC). In the case of CA, the connection between the UE and an access node of the wireless communication network is based on multiple component carriers, often denoted as PCell (Primary Cell) and SCell (Secondary Cell), which can be from different frequency bands. In the case of DC, the UE is simultaneously connected to two access nodes of the wireless communication network. Also CA and DC are typically controlled from the network side, e.g., by using RRC (Radio Resource Control) signaling.

In such procedures for controlling connectivity of the UE, robustness of the connection during the procedure is an important aspect of procedures for controlling configuration of the UE's connection to the wireless communication network. For example, one problem related to robustness at HO is that the HO command is often sent when the radio conditions for the UE are already quite bad in the source cell. That may have the effect that the HO command does not reach the UE in time, e.g., due to retransmissions or due to the message conveying the HO command being segmented.

For the 4G (4^{th} Generation) LTE (Long Term Evolution) technology and the 5G (5^{th} Generation) NR (New Radio) technology specified by 3GPP, a couple of solutions to improve mobility robustness have been proposed. For example, a concept referred to as “conditional handover” (CHO) or “early handover command” was suggested for the NR technology. The CHO concept involves that, in order to reduce dependence on radio conditions in the serving cell, RRC signaling for the HO is provided to the UE in an earlier manner. To achieve this, a HO command provided to the UE is associated with a condition based on radio conditions in the current serving cells and in neighboring cells. Such condition, may for example be met if a the signal strength from a neighbor cell becomes better by a certain margin than the current serving cell. When the condition is fulfilled, the UE executes the handover in accordance with the provided HO command.

However, the existing mechanisms may still fail to provide satisfactory results in certain scenarios, in particular when considering that future wireless communication technologies, such as a 6G (6^{th} Generation) technology, various new services and use cases may need to be supported, involving a further shift from rate-centric enhanced mobile broadband (eMBB) services of towards ultra-reliable, low latency communications (URLLC). For example, to support emerging Internet of Everything (IoE) use cases, robust mobility can be an important factor, e.g., to provider consistent service experience in hyper-high-speed railway (HSR), eXtended reality (XR) services, encompassing augmented, mixed, and virtual reality (AR/MRNR), telemedicine, haptics, flying vehicles, brain-computer interfaces, and connected autonomous systems.

Concerning mobility robustness, in particular the ability to move without suffering from radio link failure and minimized interruption time, new challenges may arise with the development of future radio technologies, e.g., operating at higher frequencies beyond 6 GHz. For example, such higher frequencies may require utilization of smaller cells, sometimes referred to as “tiny cells” having a radius of only a few tens of meters. Such denser deployments place additional burdens on mobility management and other procedures for connectivity control.

By way of example, when executing a CHO while the UE has data to transmit, e.g., in a PDCP (Packet Data Convergence Protocol) and/or RLC (Radio Link Control) buffer, it may take some time until the UE is fully capable of continuing to transmit the data in the target cell, which results in some delay in the data transmission, and such delays may sum up with an increased number of HOs due to a more dense deployment of cells. In a similar manner, a delay may for downlink data to be transmitted to the UE. From a service perspective, such delays may result in outages and failure to meet a desired QoS (Quality of Service), e.g., defined in terms of packet drop, jitter, delay requirement violation.

Accordingly, there is a need for techniques which allow for efficiently controlling connectivity in a wireless communication network.

### SUMMARY

According to an embodiment, a method of controlling connectivity to a wireless communication network is provided. According to the method, a wireless communication device monitors one or more conditions related to one or more data buffers for data to be transmitted on a wireless connection maintained by the wireless communication device. Based on the one or more conditions, the wireless communication device controls timing of executing a reconfiguration of the wireless connection.

According to an embodiment, a method of controlling connectivity to a wireless communication network is provided. According to the method, a node of the wireless communication network configures a wireless communication device to monitor one or more conditions related to one or more data buffers for data to be transmitted on a wireless connection maintained by the wireless communication device and, based on the one or more conditions, control timing of executing a reconfiguration of the wireless connection.

According to a further embodiment, a wireless communication device for operation in a wireless communication network is provided. The wireless communication device is configured to monitor one or more conditions related to one or more data buffers for data to be transmitted on a wireless connection maintained by the wireless communication device. Further, the wireless communication device is configured to, based on the one or more conditions, control timing of executing a reconfiguration of the wireless connection.

According to a further embodiment, a wireless communication device for operation in a wireless communication network is provided. The wireless communication device comprises at least one processor and a memory. The memory contains instructions executable by said at least one processor, whereby the wireless communication device is operative to monitor one or more conditions related to one or more data buffers for data to be transmitted on a wireless connection maintained by the wireless communication device. Further, the wireless communication device is configured to, based on the one or more conditions, control timing of executing a reconfiguration of the wireless connection.

According to a further embodiment, a node for a wireless communication network is provided. The node is configured to configure a wireless communication device to monitor one or more conditions related to one or more data buffers for data to be transmitted on a wireless connection maintained by the wireless communication device and, based on the one or more conditions, control timing of executing a reconfiguration of the wireless connection.

According to a further embodiment, a node for a wireless communication network is provided. The node comprises at least one processor and a memory. The memory contains instructions executable by said at least one processor, whereby the node is operative to configure a wireless communication device to monitor one or more conditions related to one or more data buffers for data to be transmitted on a wireless connection maintained by the wireless communication device and, based on the one or more conditions, control timing of executing a reconfiguration of the wireless connection.

According to a further embodiment of the invention, a computer program or computer program product is provided, e.g., in the form of a non-transitory storage medium, which comprises program code to be executed by at least one processor of a wireless communication device for operation in a wireless communication network. Execution of the program code causes the wireless communication device to monitor one or more conditions related to one or more data buffers for data to be transmitted on a wireless connection maintained by the wireless communication device. Further, execution of the program code causes the wireless communication device to, based on the one or more conditions, control timing of executing a reconfiguration of the wireless connection.

According to a further embodiment of the invention, a computer program or computer program product is provided, e.g., in the form of a non-transitory storage medium, which comprises program code to be executed by at least one processor of a node for a wireless communication network. Execution of the program code causes the node to configure a wireless communication device to monitor one or more conditions related to one or more data buffers for data to be transmitted on a wireless connection maintained by the wireless communication device and, based on the one or more conditions, control timing of executing a reconfiguration of the wireless connection.

Details of such embodiments and further embodiments will be apparent from the following detailed description of embodiments.

### BRIEF DESCRIPTION OF THE DRAWINGS

FIG. 1 schematically illustrates a wireless communication network according to an embodiment.

FIG. 2 shows an example of a HO process according to an embodiment.

FIG. 3 shows a further example of a HO process according to an embodiment.

FIG. 4 illustrates conditions considered in an exemplary HO process according to an embodiment.

FIG. 5 illustrates conditions considered in a further exemplary HO process according to an embodiment.

FIG. 6 illustrates conditions considered in a further exemplary HO process according to an embodiment.

FIG. 7 schematically illustrates an example of a procedure for estimation of a buffer status as used in an embodiment.

FIG. 8 schematically illustrates a further example of a procedure for estimation of a buffer status as used in an embodiment.

FIG. 9 shows a flowchart for schematically illustrating a method according to an embodiment.

FIG. 10 shows a block diagram for schematically illustrating functionalities of a wireless communication device according to an embodiment.

FIG. 11 shows a flowchart for schematically illustrating a further method according to an embodiment.

FIG. 12 shows a block diagram for schematically illustrating functionalities of a network node according to an embodiment.

FIG. 13 schematically illustrates structures of a wireless communication device according to an embodiment.

FIG. 14 schematically illustrates structures of a network node according to an embodiment.

### DETAILED DESCRIPTION

In the following, concepts in accordance with exemplary embodiments of the invention will be explained in more detail and with reference to the accompanying drawings. The illustrated embodiments relate to connectivity management in a wireless communication network, in particular with respect to execution of a connection reconfiguration procedure. The wireless communication network could for example be based on the 4G LTE technology, the 5G NR technology, or a 6G technology.

In the illustrated concepts a wireless communication device maintains a wireless connection. In some scenarios, the wireless communication device may be a UE and maintain the wireless connection to the wireless communication network, e.g., to an access node of the wireless communication network. In other scenarios, the wireless communication device could be an access node of the wireless communication network and could maintain the wireless connection to a UE. For controlling reconfiguration of the wireless communication, one or more conditions related to a data buffer for transmission of data on the wireless connection are considered. In particular, these one or more conditions are considered to control a timing of executing the reconfiguration. In this way, it becomes possible to execute the reconfiguration at a time which minimizes or at least reduces adverse effects on ongoing transmissions of data, such as outages caused during mobility of the UE. The reconfiguration may for example be a CHO from one cell to another cell of the wireless communication network. However, the illustrated concepts could also be applied to other reconfiguration procedures. For example, such other reconfiguration procedures could include a network-triggered HO, or a change in a carrier aggregation configuration used for the wireless connection, e.g., a Conditional PSCell (Primary Serving Cell) Change (CPC), a Conditional PSCell Addition (CPA), and/or a Conditional PSCell Change/Addition (CPAC). The latter procedures are examples of procedures involving addition or change of component carriers in a carrier aggregation configuration. Another example of such other reconfiguration procedure is a conditional resume procedure, in which upon fulfillment of a condition the UE executes a resume procedure by transmitting a resume request, e.g., to re-establish a wireless connection after a radio link failure (RLF), or a procedure for activation, deactivation, or modification of DC which is controlled in a conditional manner by the UE or from the network side.

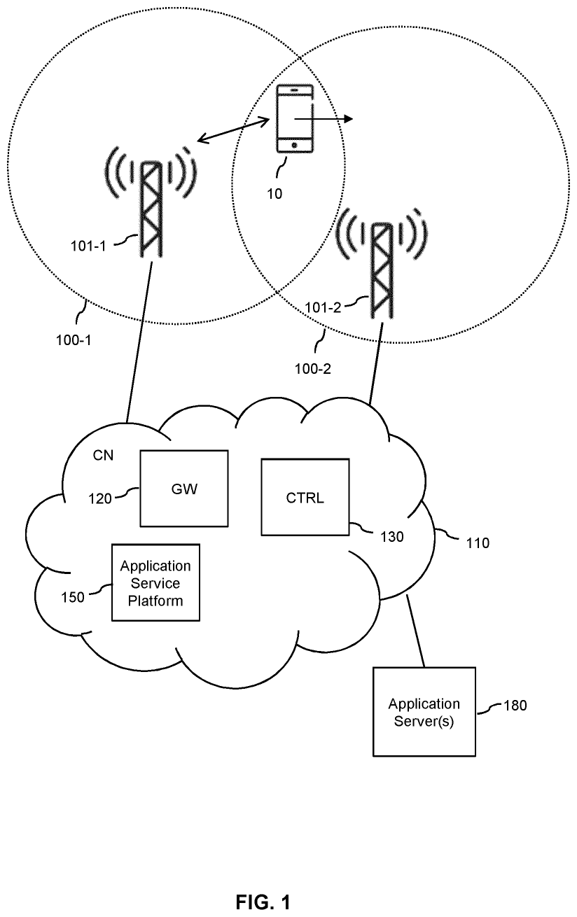

FIG. 1 illustrates an exemplary wireless communication network according to an embodiment. In the illustrated example, the wireless communication network covers multiple cells 100-1, 100-2, each cell being served by a corresponding access node 101-1, 101-2. The access nodes 101-1, 101-2 may for example correspond to eNBs of the 4G LTE technology, to gNBs of the 5G NR technology, or to access nodes of a 6G technology.

By way of example, FIG. 1 further illustrates a UE 10 connected to the wireless communication network. The UEs 10 may correspond to various kinds of wireless communication devices, for example user terminals, such as mobile or stationary computing devices like smartphones, laptop computers, desktop computers, tablet computers, gaming devices, or the like. Further, the UEs 10s could for example correspond to other kinds of wireless communication enabled equipment like smart home devices, printers, multimedia devices, data storage devices, or the like.

In the example of FIG. 1, the UEs 10 is assumed to be connected by a wireless connection maintained to a first cell 100-1 served by the access node 101-1, but moving toward a second cell 100-2, served by the access node 101-2. This may result in reconfiguration of the wireless connection so that, after a reconfiguration procedure, the UE 10 is connected to the second cell 100-2. The reconfiguration procedure can for example be a CHO triggered by the UE 10 itself or a HO triggered from the network side, e.g., by the access node 101-1.

As further illustrated, the access nodes 101-1, 101-2 may be further connected to a core network (CN) 110 of the wireless communication network. The CN 110 may ensure data connectivity of the UE 10 with other UEs connected to the wireless communication network (not illustrated) as well as data connectivity of the UE 10 to other entities, e.g., to one or more servers, service providers, data sources, data sinks, user terminals, or the like. For this purpose, the CN 110 may include one or more gateways 120. The wireless connection established between the UE 10 and the wireless communication network may be used for providing various kinds of services to the UE 10, e.g., a voice service, a multimedia service, or other data service. Such services may be based on applications which are executed on the UE 10 and/or on a device linked to the UE 10. By way of example, FIG. 1 illustrates an application service platform 150 provided in the CN 110 and one or more application servers 180 connected to the CN 110. The application(s) executed on the UE 10 and/or on one or more other devices linked to the UE 10 may use the data link of the UE 10 for data communication with one or more other UEs 10, the application service platform 150, and/or the application server(s) 180, thereby enabling utilization of the corresponding service(s) at the UE 10. As further elements of the CN 110, FIG. 1 also illustrates a control node 130. The control node 130 may at least in part be responsible for controlling or otherwise managing the reconfiguration procedure, e.g., by providing corresponding configuration information to the UE 10 and/or to the access nodes 101-1, 101-2.

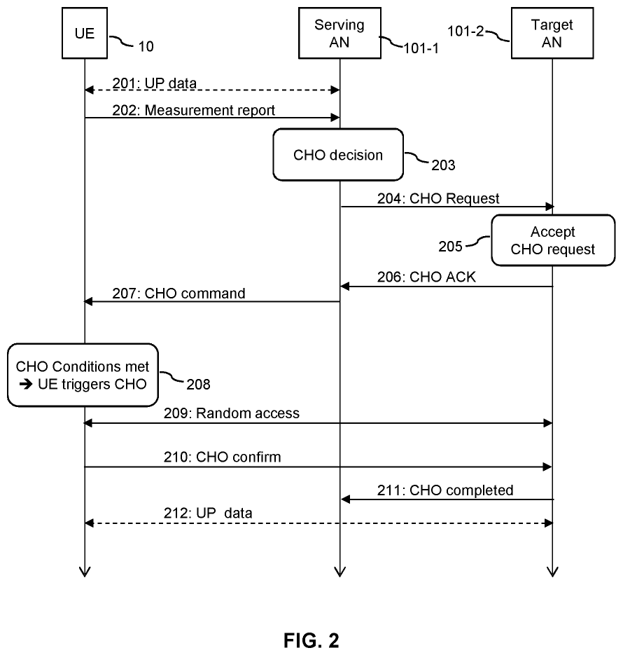

In the following, the illustrated concepts will be explained in more detail by referring to a reconfiguration procedure corresponding to a CHO. FIG. 2 schematically illustrates processes of the reconfiguration procedure. The processes of FIG. 2 involve the UE 10, the access node 101-1 initially serving the UE 10, in the following referred to as serving access node (AN) 101-1, and the access node 101-2 to which the CHO of the UE 10 is performed, in the following also referred to as target AN 101-2. The cell served by the serving AN 101-1 may also be denoted as source cell of the CHO, and the cell served by the target AN 101-2 may also be referred to as target cell of the CHO.

In the processes of FIG. 2, it is assumed that the wireless connection between the UE 10 an the wireless communication network is initially maintained to the serving AN 101-1. Accordingly, an exchange of user plane (UP) data 201 may be performed between the UE 10 and the serving AN 101-1. The UP data 201 may include uplink (UL) data transmitted from the UE 10 to the wireless communication network and/or downlink (DL) data transmitted from the wireless communication network to the UE 10. As further illustrated in FIG. 2, the UE 10 may send a measurement report 202 to the serving AN 101-1. The measurement report 202 may for example indicate a signal quality measured with respect to the target AN 101-2. Based on the measurement report 202, the serving AN 101-1 may take a CHO decision 203. The CHO decision 203 involves that, if certain conditions monitored by the UE 10 are met, the UE 10 shall trigger execution of the CHO to the target AN 101-2. The CHO decision 203 may also involve that the serving AN 101-1 selects the target cell, e.g., based on the measurement report 202. In some scenarios, the CHO decision 203 could also involve that the serving AN 101-1 selects multiple target cells to be used as candidates among which the UE 10 can select the target cell to which the CHO is executed.

As further illustrated, for preparing the CHO, the serving AN 101-1 may send a CHO request 204 to the target AN 101-2. Upon accepting the CHO request 204, as indicated by block 205, the target AN 101-2 may send a CHO acknowledgement (CHO ACK) 206 to the serving AN 101-1. The serving AN 101-1 may then proceed to sending a CHO command 207 to the UE 10. The CHO command 207 indicates to the UE 10 that, upon fulfilment of certain conditions, it shall trigger execution of the CHO to the target AN 101-1. The CHO command 207 may for example indicate the target AN 101-2, e.g., in terms of an cell identifier of the target cell, and/or parameters for accessing the target cell. Further, the CHO command 207 may indicate at least some of the conditions to be fulfilled for triggering execution of the CHO. The CHO command 207 may also define the execution of the CHO, e.g., by including an RRC Connection Reconfiguration message to be executed by the UE 10 when condition(s) are satisfied.

The conditions include one or more conditions related to a data buffer for UP data to be transmitted on the wireless connection between the UE 10 and the wireless communication network. The data buffer could for example provided on a PDCP layer or on an RLC layer of the wireless connection's protocol stack. Further, the conditions may include one or more conditions related to signal quality of the source cell and/or signal quality of the target cell. For example, such conditions based on signal quality could be similar to the conditions considered in an A3 event of the 5G NR technology or 4G LTE technology. The conditions could for example require that when the RSRP (Reference Signal Received Power) of the target cell becomes better than the RSRP of the serving cell plus an offset and a margin, an event entry condition is satisfied and if this event entry condition continues to be fulfilled for a time interval denoted as time-to-trigger (TTT), the UE 10 may trigger execution of the CHO. Instead of RSRP, signal quality of the source cell and target cell could also be measured in terms of RSRQ (Reference Signal Received Quality) or SINR (Signal to Interference and Noise Ratio).

Accordingly, the UE 10 could be configured to execute the CHO when the signal quality of the target cell becomes better, typically by a certain offset plus a margin, than the signal quality of the source cell and at least one of the following conditions is fulfilled: A first type of condition may consider a data buffer for UL data to be transmitted by the UE 10, in the following also denoted as UL buffer. For example, such condition could require that the UL buffer is empty and the UE 10 is not expected to transmit UP data before it has connected to the target cell. In some variants, this condition could also be relaxed by requiring that the UL buffer is empty and the UE 10 is not expected to transmit any delay sensitive UP data before it has connected to the target cell. In some variants, this condition could be further relaxed by just requiring that the UL buffer is empty. In some variants, this condition could be still further relaxed by requiring that a fill level of the UL buffer is below a threshold. A second type of condition may consider a data buffer for DL data to be transmitted to the UE, in the following also denoted as DL buffer. For example, such condition could require that the DL buffer is expected to be empty and is expected to remain empty until the UE 10 has connected to the target cell. In some variants, this condition could also be relaxed by requiring that the DL buffer is expected to be empty and the UE 10 is not expected to receive any delay sensitive UP data before it has connected to the target cell. In some variants, this condition could be further relaxed by just requiring that the DL buffer is expected to be empty. In some variants, this condition could be still further relaxed by requiring that a fill level of the DL buffer is expected to be below a threshold.

Such conditions can be configured from the network side, e.g., by the serving AN 101-1 and/or the control node 130. For example, such configuration could involve sending an indication that the UE 10 shall base the condition on the UL buffer or sending an indication that the UE 10 shall base the condition on the DL buffer, or sending an indication that the UE 10 shall base the condition on both the UL buffer and the DL buffer. Such indication could be sent as part of the CHO command 207 or in a separate configuration procedure, e.g., during initial RRC configuration establishment between the UE 10 and the wireless communication network. In some scenarios, at least a part of such conditions could also be pre-configured in the UE 10.

In some scenarios, the wireless connection can be based on multiple bearers, e.g., corresponding to different Quality of Service (QoS) features, and the configuration of the conditions could be accomplished on a per-bearer basis. For example, such condition defined on a per-bearer basis could require that for at least one of the bearers the UL buffer is empty and the UE 10 is not expected to transmit UP data before it has connected to the target cell and/or that for at least one of the bearers the DL buffer is expected to be empty and is expected to remain empty until the UE 10 has connected to the target cell. This may allow the UE 10 to trigger execution of the CHO even though there is a non-empty data buffer, e.g., if this non-empty data buffer is associated with a bearer for data traffic that is not sensitive to delay or outages.

In addition to or as an alternative to configuring the conditions on a per-bearer basis, the conditions could also be configured per service and/or per area, e.g., to be valid for only one or more configured candidate target cells.

In the example of FIG. 2, it is assumed that at block 208 the UE 10 detects that the conditions for triggering execution of the CHO are met and thus proceeds to execution of the CHO. As illustrated, this may involve that the UE 10 performs a random access 209 in the target cell and sends a message 210 for confirming successful execution of the CHO to the target AN 101-2. After that the target AN 101-2 may send a message 211 indicating completion of the CHO to the serving AN 101-1. At that point, execution of the CHO may be considered as being completed. The target AN 101-2 then becomes the new serving AN of the UE 10 and the UE 10 may continue exchanging UP data 212 with this new serving AN 101-2.

As can be seen from the explanations in connection with FIG. 2, the UE 10 may trigger execution of the CHO in an appropriate manner by additionally considering the data buffers for UL data and/or DL data. In this way, it can be avoided that data to be transmitted is delayed by execution of the CHO or at least the amount of data being delayed can be reduced or limited to bearers, services, or areas which are not sensitive to delay or outages. As a result, overall QoS on the wireless connection can be improved. This can be particularly relevant for URLLC applications or applications requiring low interruption times in connection with high data rates, such as XR, AR, MR, or VR applications. Further, a CHO procedure based on the illustrated concepts can also be applied in cases where the wireless connection uses carrier aggregation or dual connectivity.

In some scenarios, triggering execution of the CHO considering at block 208 may be based on a timer, in the following denoted as timer T304*. The timer may be specified by defining a start condition, a stop condition, and one or more actions to be performed by the UE at expiry of the timer T304*.

According to an example, the start condition for the timer T304* is fulfillment of the signal quality based conditions for triggering execution of the CHO and that the considered data buffer is not empty and/or not expected to remain empty until execution of the CHO is completed. Accordingly, the timer T304* may be started when upon fulfilment of the signal-quality based conditions for triggering the CHO the data buffer holds data to be transmitted and/or UE predicts there will be no time to complete CHO execution without having an interruption. The network can specify the value that should be assigned to the timer in the CHO command.

The stop condition for the timer T304* may be determined by the status of the considered data buffer. In particular, the stop condition may be considered as fulfilled when the considered data buffer is detected or estimated to be empty or to remain empty for a configurable time span. Upon stopping of the timer T304*, the UE 10 may proceed to trigger execution of the CHO. Further, irrespective of the status of the considered data buffer, the stop condition could consider signal quality of the source cell, e.g., in terms of RSRP, RSRQ, or SINR. If the signal quality falls below a given threshold, the UE 10 may stop the timer T304* and trigger execution of the CHO, in order to avoid losing the connection to the serving AN 101-11 due to RLF. When triggering execution of the CHO, the UE 10 may also start a further timer for assessing successful completion of the CHO, such as the T304 timer specified for the 5G NR technology.

Upon expiry of the timer T304*, the UE 10 may trigger execution of the CHO. When triggering execution of the CHO, the UE 10 may also start a further timer for assessing successful completion of the CHO, such as the T304 timer specified for the 5G NR technology. Alternatively or in addition, the UE 10 inform the serving AN 101-1 about the consideration of the data buffer when executing the CHO. For example, the UE 10 may inform the serving AN 101-1 whether or not it was possible to fulfil the condition(s) related to the data buffer when triggering the CHO. This information could then be used by the serving AN 101-1 or other nodes of the wireless communication network to optimize the process of considering the data buffer when triggering execution of the CHO, e.g., by adjusting a value of the timer T304* or other parameters

In some cases, the UE 10 could also predict that the value set for the timer T304* is too low, i.e., that upon expiry of the timer T304* the considered data buffer will not be empty. In such case, the UE 10 could perform one or more of the following actions. The UE 10 may inform the serving AN 101-1 or another node of the wireless communication network that signal-quality based conditions for triggering execution of the CHO are met but the value set to for the timer is too low. In response, the serving AN 101-1 could delay CHO execution and/or adapt the value set for the timer T304*. Further, the UE 10 could just proceed to triggering execution of the CHO.

In some scenarios, triggering execution of the CHO considering at block 208 may be based prediction of the status of the considered data buffer. Based on such prediction, the UE 10 may determine an exact time for triggering execution of the CHO, so that the CHO is executed when the considered data buffer is empty. In particular, the UE 10 may use the prediction of the buffer status to identify a time interval in which the data buffer is expected to remain empty and which allows for completing execution of the CHO. If the UE 10 determines that the data buffer will not become empty in an allowed time window, e.g., configured by the wireless communication network, the UE 10 may immediately trigger execution of the CHO. Further, the UE 10 could delay triggering execution even though the considered data buffer is empty and trigger execution of the CHO at a later time, which according to the prediction is better suited for execution of the CHO, e.g., because the data buffer is expected to remain empty for a longer time.

Further, the UE 10 may inform the serving AN 101-1 or other nodes of the wireless communication network about the predictions related to the data buffer, e.g., in a measurement report or in a buffer status report. The serving AN 101-1 and or other nodes of the wireless communication network may then use this information to determine whether the UE should be allowed to delay execution of the CHO based on data buffer related condition, optimize the time window in which the UE 10 is allowed to delay execution of the CHO and/or adapt scheduling of the UE 10, e.g., by providing additional DL grants and/or UL grants to expedite emptying of the data buffer. The serving AN 101-1 or other nodes of the wireless communication network could, for example, set a higher priority weight for scheduling resources for the UE 10.

Further, based on the prediction of the status of the considered data buffer, the UE 10 may prioritize candidate target cells. For example, the UE 10 may refrain from triggering execution of the CHO to one candidate target cell, if the prediction indicates that the UE 10 will be able to connect to another candidate target while the considered data buffer is empty. Such decision may be further based on signal quality of the source cell and the considered target cells. In some cases, such decision could also be based on a machine learning model to assess a risk of a RLF. Such machine learning model could for example be trained using training data indicating occurrences of RLFs and associated signal-qualities observed by the UE 10.

In some scenarios, delaying the triggering of execution of the CHO at block 208 may also be based on a combination of conditions related to the data buffer and one or more conditions related to signal quality of the source cell and/or signal quality of the target cell. In this way, it can be taken into account that delaying the execution of the CHO might negatively affect performance of the wireless communication network, because the typically configured signal-quality based conditions are optimized to ensure that the UE 10 can connect to a better cell before the UE's 10 performance in its current serving cell severely degrades. Delaying execution of the CHO may have the effect that the UE 10 operates under poor signal conditions, with reduced performance, and/or that there is additional interference for other UE's 10 or cells. Accordingly, the delaying of the CHO may be further controlled depending on signal quality based conditions, and such additional conditions may be configured from the network side, e.g., by the serving AN 101-1 or some other node, such as the above-mentioned control node.

According to an example, the UE 10 could be configured to allow delaying of execution of the CHO only if the signal quality of the source cell, e.g., measured in terms of RSRP, RSRQ, SINR, is above a threshold. Such threshold may in turn be configurable from the network side, e.g., by the serving AN 101-1 or some other node, such as the above-mentioned control node 130. In this way, it can be ensured that the UE's 10 wireless connection can be maintained with a certain quality, and without RLF, while still allowing to empty the data buffer.

In addition or as an alternative, the UE 10 could be configured to allow delaying of execution of the CHO only if the signal quality of the source cell, e.g., measured in terms of RSRP, RSRQ, SINR, is predicted to remain above a threshold until the data buffer can be emptied. Such threshold may in turn be configurable from the network side, e.g., by the serving AN 101-1 or some other node, such as the above-mentioned control node 130. For this purpose, the UE 10 may predict the signal quality of the source cell, e.g., by extrapolating the latest development of the source cell and/or by using a machine learning model. Further, the UE 10 may predict how long it would take to empty the data buffer.

In addition or as an alternative, the UE 10 could be configured to allow delaying of execution of the CHO only when a difference in signal quality between the source cell and the target cell is within a certain range. Such threshold may in turn be configurable from the network side, e.g., by the serving AN 101-1 or some other node, such as the above-mentioned control node 130.

In CHO processes as illustrated in FIG. 2, the source AN 101-1 may participate in the following way: The source AN 101-1 may configure the UE 10 and the target cell, or multiple candidate target cells, for a possible CHO taking into account the status of the data buffer. This may also include informing the target AN 101-2 that the CHO is performed taking into account buffer status and thus possible delayed or otherwise modified in timing, e.g., by executing the CHO prematurely before a target time. Examples of configurations made with respect to the UE 10 include: indicating that the UE 10 shall consider the status of the data buffer when triggering execution of the CHO, indicating which data buffer(s) the UE 10 shall consider when triggering execution of the CHO, indicating the condition(s) to be considered with respect to the data buffer(s). Further examples of configurations made with respect to the UE 10 include the value of the timer T304*, a minimum signal quality of the source cell to allow a UE to delay execution of the CHO if the considered data buffer is not empty, a minimum signal quality of the target cell to allow a UE 10 to prematurely trigger execution of the CHO execution if the considered data buffer is empty. Further, the source AN 101-1 may configure the UE 10 to perform predictions of DL buffer status and/or UL data buffer status, e.g., predictions when the data buffer is expected to become empty and/or when data is expected to arrive in the data buffer. Further, the serving AN 101-1 could perform predictions of DL data buffer status and/or of UL buffer status and report such predictions to the UE 10. Further, the serving AN 101-1 could receive reports from the UE 10. Such reports could for example indicate a current and/or predicted status of the UL buffer maintained by the UE 10. Depending on such reports, the serving AN 101-1 could adapt scheduling of the UE 10, e.g., by giving the UE 10 higher priority when scheduling resources of the source cell, so that the data buffer(s) of the UE 10 can be emptied more quickly. Such prioritization of scheduling of the UE 10 could for example be performed in response to the UE 10 reporting that the signal-quality based conditions for triggering execution of the CHO are already fulfilled, but the data buffer(s) considered in the other condition(s) are not yet empty.

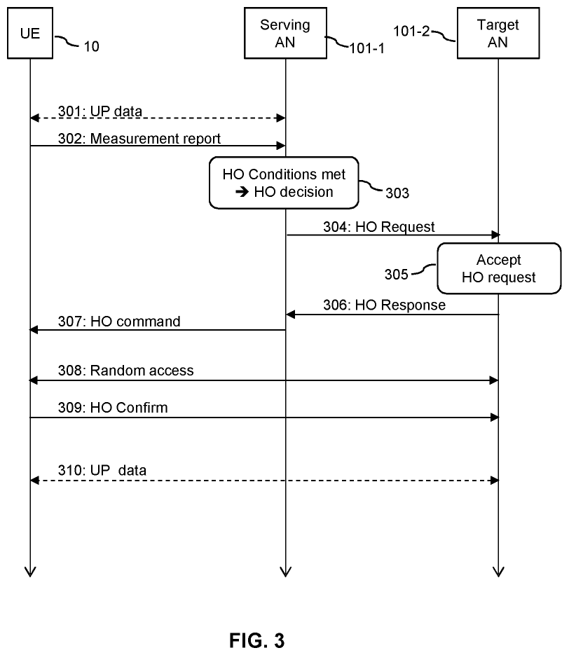

FIG. 3 schematically illustrates processes of a further type of reconfiguration procedure, involving a HO triggered on the network side. The processes of FIG. 3 involve the UE 10, the access node 101-1 initially serving the UE 10, in the following referred to as serving access node (AN) 101-1, and the access node 101-2 to which the HO of the UE 10 is performed, in the following also referred to as target AN 101-2. The cell served by the serving AN 101-1 may also be denoted as source cell of the HO, and the cell served by the target AN 101-2 may also be referred to as target cell of the HO.

In the processes of FIG. 3, it is assumed that the wireless connection between the UE 10 an the wireless communication network is initially maintained to the serving AN 101-1. Accordingly, an exchange of UP data 301 may be performed between the UE 10 and the serving AN 101-1. The UP data 201 may include UL data transmitted from the UE 10 to the wireless communication network and/or DL data transmitted from the wireless communication network to the UE 10. As further illustrated in FIG. 3, the UE 10 may send a measurement report 302 to the serving AN 101-1. The measurement report 302 may for example indicate a signal quality measured with respect to the target AN 101-2. Based on the measurement report 302, the serving AN 101-1 takes a HO decision 303. The HO decision 303 involves that, if certain conditions are met, the serving AN 101-1 UE 10 triggers execution of the HO to the target AN 101-2.

The conditions considered in the HO decision 303 include one or more conditions related to a data buffer for UP data to be transmitted on the wireless connection between the UE 10 and the wireless communication network. The data buffer could for example provided on a PDCP layer or on an RLC layer of the wireless connection's protocol stack. Further, the conditions may include one or more conditions related to signal quality of the source cell and/or signal quality of the target cell. For example, the HO decision 303 could involve executing the HO when the signal quality of the target cell becomes better, typically by a certain margin, than the signal quality of the source cell and at least one of the following conditions is fulfilled: A first type of condition may consider a UL buffer, i.e., a data buffer for UL data to be transmitted by the UE 10. For example, such condition could require that the UL buffer is expected to be empty and the UE 10 is not expected to transmit UP data before it has connected to the target cell. In some variants, this condition could also be relaxed by requiring that the UL buffer is expected to be empty and the UE 10 is not expected to transmit any delay sensitive UP data before it has connected to the target cell. In some variants, this condition could be further relaxed by just requiring that the UL buffer is expected to be empty. In some variants, this condition could be still further relaxed by requiring that a fill level of the UL buffer is expected to be below a threshold. A second type of condition may consider a DL, buffer, i.e., a data buffer for DL data to be transmitted to the UE 10, e.g., maintained by the serving AN 101-1. For example, such condition could require that the DL buffer is empty and is expected to remain empty until the UE 10 has connected to the target cell. In some variants, this condition could also be relaxed by requiring that the DL buffer is empty and the UE 10 is not expected to receive any delay sensitive UP data before it has connected to the target cell. In some variants, this condition could be further relaxed by just requiring that the DL buffer is empty. In some variants, this condition could be still further relaxed by requiring that a fill level of the DL buffer is below a threshold.

Such conditions can be configured by the wireless communication network, e.g., by the control node 130. For example, such configuration could involve sending an indication that the serving AN 101-1 shall base the condition on the UL buffer or sending an indication that the serving AN 101-1 shall base the condition on the DL buffer, or sending an indication that the serving AN 101-1 shall base the condition on both the UL buffer and the DL buffer. Such indication could be sent during initial RRC configuration establishment between the UE 10 and the wireless communication network. In some scenarios, at least a part of such conditions could also be pre-configured in the serving AN 101-1.

In some scenarios, the wireless connection can be based on multiple bearers, e.g., corresponding to different QoS features, and the configuration of the conditions could be accomplished on a per-bearer basis. For example, such condition defined on a per-bearer basis could require that for at least one of the bearers the UL buffer is expected to be empty and the UE 10 is not expected to transmit UP data before it has connected to the target cell and/or that for at least one of the bearers the DL buffer is empty and is expected to remain empty until the UE 10 has connected to the target cell. This may allow the serving AN 101-1 to trigger execution of the HO even though there is a non-empty data buffer, e.g., if this non-empty data buffer is associated with a bearer for data traffic that is not sensitive to delay or outages.

In addition to or as an alternative to configuring the conditions on a per-bearer basis, the conditions could also be configured per service and/or per area, e.g., to be valid for only one or more configured candidate target cells.

As further illustrated, for preparing the HO, the serving AN 101-1 may send a HO request 304 to the target AN 101-2. To confirm acceptance of the HO request 304, as indicated by block 305, the target AN 101-2 may send a HO response 306 to the serving AN 101-1. The serving AN 101-1 may then proceed to triggering execution of the HO by sending a HO command 307 to the UE 10. The HO command 307 instructs the UE 10 to detach from its serving cell and connect to the target cell. The HO command 307 may for example indicate the target AN 101-2, e.g., in terms of an cell identifier of the target cell, and/or parameters for accessing the target cell.

As illustrated in FIG. 3, execution of the HO may involve that the UE 10 performs a random access 308 in the target cell and sends a message 309 for confirming successful execution of the HO to the target AN 101-2. The target AN 101-2 then becomes the new serving AN of the UE 10 and the UE 10 may continue exchanging UP data 310 with this new serving AN 101-2.

As can be seen from the explanations in connection with FIG. 3, the serving AN 101-1 may trigger execution of the HO in an appropriate manner by additionally considering the data buffers for UL data and/or DL data. In this way, it can be avoided that data to be transmitted is delayed by execution of the CHO or at least the amount of data being delayed can be reduced or limited to bearers, services, or areas which are not sensitive to delay or outages. As a result, overall QoS on the wireless connection can be improved. This can be particularly relevant for URLLC applications or applications requiring low interruption times in connection with high data rates, such as XR, AR, MR, or VR applications. Further, a HO procedure based on the illustrated concepts can also be applied in cases where the wireless connection uses carrier aggregation or dual connectivity.

In some scenarios, the above-mentioned conditions related to the UL buffer and/or DL buffer may be supplemented by further conditions. For example, such further conditions could avoid that execution of a CHO or HO is not excessively delayed by a condition related to the UL buffer or DL buffer not being met. For example, such further condition could be based on signal quality of the source cell and target cell and trigger immediate execution of the CHO or HO, regardless of the UL buffer status and/or DL buffer status, if the difference in signal quality between source cell and target cell exceeds threshold or if the signal quality of the source cell quality falls below a threshold. Further, such further condition could involve triggering immediate execution of the CHO or HO if for some other reason a radio link failure (RLF) is to be expected in the source cell. By avoiding excessive delaying of the CHO or HO, it can be avoided that the UE 10 loses connectivity before connecting to the target cell. Further, it can be avoided that maintaining the connection to the source cell, which may be unfavorable in terms of signal conditions, creates interference to other cells.

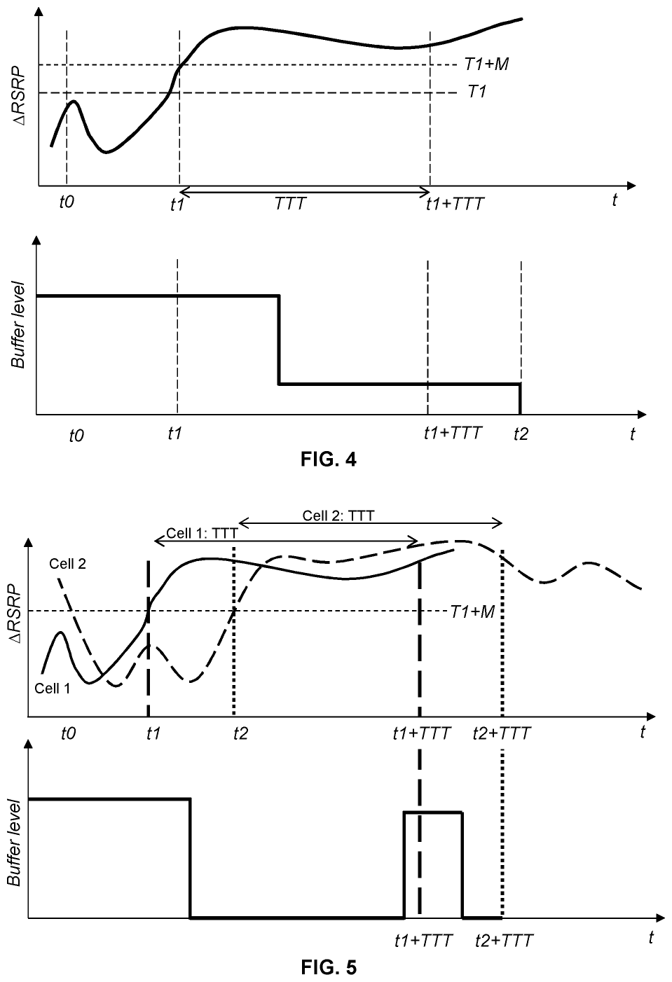

FIG. 4 schematically illustrates timing of an exemplary CHO procedure which is based on the above-described concepts. As mentioned above, the CHO procedure is based on providing the UE with conditions for triggering execution of the CHO and that these conditions may include one or more conditions related to signal quality of the source cell and the target cell and one or more conditions related to data buffers for UL data and/or DL data to be transmitted on the wireless connection between the UE and the wireless communication network. In the example of FIG. 4 it is assumed that these conditions include a first condition requiring that when the RSRP of the target cell becomes better than the RSRP of the serving cell plus an offset and a margin, an event entry condition is satisfied and if this event entry condition continues to be fulfilled for a time interval TTT, the UE 10 may trigger execution of the CHO. Further, the conditions include a second condition, requiring that a data buffer for data to be transmitted on the wireless connection is empty when the UE triggers the execution of the CHO. The data buffer may be a UL buffer or a DL buffer, e.g., maintained on the PDCP layer or on the RLC layer. FIG. 4 shows an exemplary course of the RSRP difference (ARSRP) between the source cell and the target cell and of the buffer level of the considered data buffer.

In the example of FIG. 4, at time t0 the UE receives the CHO command. At time t1, the RSRP difference between the source cell and the target cell exceeds a threshold T1 plus a margin M, and the entry condition of the first condition is satisfied. Further, the entry condition continues to be satisfied until end of the TTT at t1+TTT, so that the first condition is fulfilled. However, at t1+TTT, the data buffer is not empty. As a result, the UE delays triggering execution of the CHO until t2, when the buffer level falls to zero and, thus, also the second condition is met. Accordingly, in the example of FIG. 4, the first condition sets a target time for execution of the CHO, at t1+TTT, but execution of the CHO is delayed until t2 when the data buffer considered by the second condition becomes empty.

FIG. 5 schematically illustrates timing of a further exemplary CHO procedure which is based on the above-described concepts. As mentioned above, the CHO procedure is based on providing the UE with conditions for triggering execution of the CHO and that these conditions may include one or more conditions related to signal quality of the source cell and multiple candidate targets cell and one or more conditions related to data buffers for UL data and/or DL data to be transmitted on the wireless connection between the UE and the wireless communication network. In the example of FIG. 5 it is assumed that these conditions include a first condition requiring that when the RSRP of one of the candidate target cells becomes better than the RSRP of the serving cell plus an offset and a margin, an event entry condition is satisfied and if this event entry condition continues to be fulfilled for a time interval TTT, the UE 10 may select this candidate target cell as target cell for the CHO and trigger execution of the CHO. If the entry condition is fulfilled for multiple target cells until the end of the respective TTT, the UE may select the candidate target cell with the highest RSRP. Further, the conditions include a second condition, requiring that a data buffer for data to be transmitted on the wireless connection is empty when the UE triggers the execution of the CHO. The data buffer may be a UL buffer or a DL buffer, e.g., maintained on the PDCP layer or on the RLC layer. FIG. 5 shows an exemplary course of the RSRP difference (ARSRP) between the source cell and the target cell and of the buffer level of the considered data buffer. The RSRP difference for a first candidate target cell (Cell 1) is represented by a broken line, and the RSRP difference for a second candidate target cell (Cell 2) is represented by a solid line. In a variant of a procedure as illustrated by FIG. 4, the UE could immediately trigger execution of the CHO if the data buffer considered in the second condition is empty at t1+TTT. In a further variant, the delaying of triggering the execution of the CHO could involve that, in response to the data buffer considered in the second condition not being empty at t1+TTT, the UE waits for a delay time D, i.e., until t1+TTT+D, and triggers execution of the CHO if the data buffer is empty at t1+TTT+D and otherwise further delays triggering execution of the CHO. In a still further variant, the delaying of triggering the execution of the CHO could involve that, in response to the data buffer considered in the second condition not being empty at t1+TTT, the UE waits for a delay time D, i.e., until t1+TTT+D, and triggers execution of the CHO if the data buffer is empty at t1+TTT+D, irrespective of the buffer level of the data buffer considered in the second condition. The delay time D may be configurable from the network side, e.g., using configuration information provided in the CHO command or in some other control message sent to the UE.

As already explained, in the proposed method, after the fulfillment of a CHO execution condition, the UE delays the execution based on data buffer information. The goal is to empty the UE's buffer before disconnecting from the source cell and/or to avoid the disconnection with source while there is data in buffer and/or to perform a CHO when data is not expected to arrive in buffer until the UE connects with target. When the execution condition is satisfied, e.g., at (t1+TTT) in FIG. 4, the UE determines the status of its buffer. If the buffer is empty, it immediately executes the CHO, otherwise it waits for a certain time, e.g., configurable by network, in order to give time to empty the buffer, and then executes the CHO, e.g., at t2 in FIG. 4. If the buffer is not empty by that time, the UE executes the CHO anyway.

In the example of FIG. 5, at time t0 the UE receives the CHO command, indicating Cell 1 and Cell 2 as candidate target cells of the CHO. At time t1, the RSRP difference for Cell 1 exceeds the threshold T1 plus M, and the entry condition of the first condition is satisfied for Cell 1. At time t2, the RSRP difference for Cell 2 exceeds the threshold T1 plus M, and the entry condition of the first condition is satisfied for Cell 2. Further, for Cell 1 the entry condition continues to be satisfied until end of the respective TTT at t1+TTT, so that the first condition is fulfilled for Cell 1. However, at t1+TTT, the data buffer is not empty. As a result, the UE does not trigger execution of the CHO at t1+TTT. Further, for Cell 2 the entry condition continues to be satisfied until end of the respective TTT at t2+TTT, so that the first condition is fulfilled for Cell 2. At this time, the data buffer considered in the second condition is empty so that also the second condition is met. As a result, the UE selects Cell 2 as the target cell of the CHO and triggers execution of the CHO at t2+TTT.

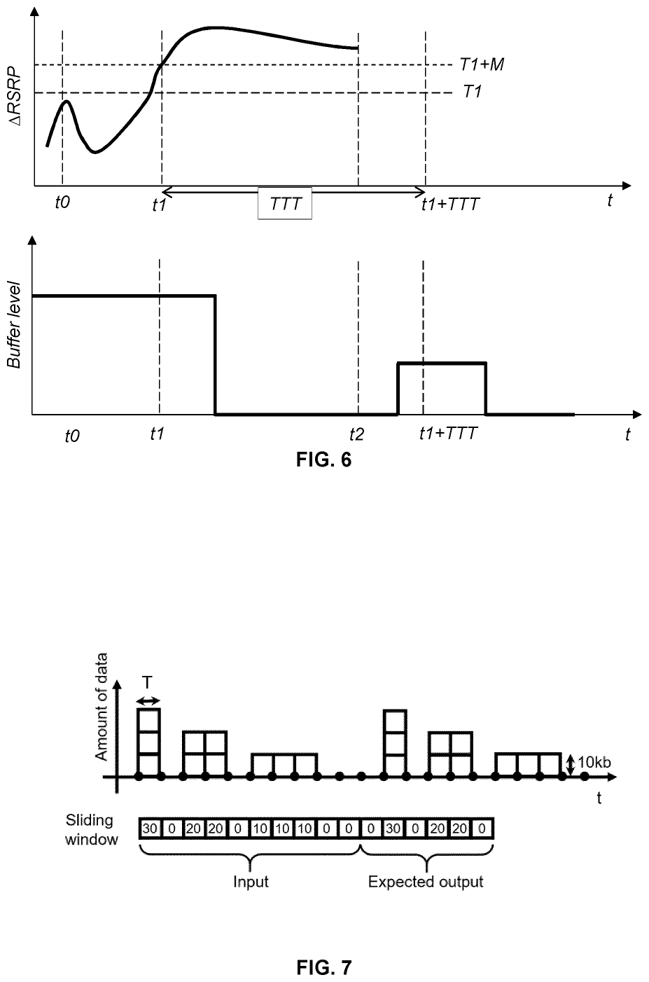

FIG. 6 schematically illustrates timing of a further exemplary CHO procedure which is based on the above-described concepts. As mentioned above, the CHO procedure is based on providing the UE with conditions for triggering execution of the CHO and that these conditions may include one or more conditions related to signal quality of the source cell and the target cell and one or more conditions related to data buffers for UL data and/or DL data to be transmitted on the wireless connection between the UE and the wireless communication network. In the example of FIG. 6 it is assumed that these conditions include a first condition requiring that when the RSRP of the target cell becomes better than the RSRP of the serving cell plus an offset and a margin, an event entry condition is satisfied and if this event entry condition continues to be fulfilled for a time interval TTT, the UE 10 may trigger execution of the CHO. Further, the conditions include a second condition, requiring that a data buffer for data to be transmitted on the wireless connection is empty when the UE triggers the execution of the CHO and that the UE may trigger execution of the CHO already before expiry of the time interval TTT if the data buffer is empty. The data buffer may be a UL buffer or a DL buffer, e.g., maintained on the PDCP layer or on the RLC layer. FIG. 6 shows an exemplary course of the RSRP difference (ARSRP) between the source cell and the target cell and of the buffer level of the considered data buffer.

In the example of FIG. 6, at time t0 the UE receives the CHO command. At time t1, the RSRP difference between the source cell and the target cell exceeds a threshold T1 plus a margin M, and the entry condition of the first condition is satisfied. Further, the entry condition continues to be satisfied until the data buffer considered in the second condition becomes empty at t2. As a result, the UE prematurely triggers execution of the CHO already before expiry of the time interval TTT at t2, when the buffer level falls to zero and the second condition is met. Accordingly, in the example of FIG. 6, the first condition sets a target time for execution of the CHO, at t1+TTT, but execution of the CHO is prematurely triggered at t2 when the data buffer considered by the second condition becomes empty.

Prematurely triggering execution of the CHO like in the example of FIG. 6 may be based on additional conditions defining whether it is allowed to consider the first condition as being met even though the time interval TTT has not yet expired. This may help to reduce a risk of failure of the CHO or a risk of occurrence of a ping-pong HO problem. For example, such additional conditions may consider a signal quality of the target cell, e.g., by requiring that premature triggering of execution of the CHO is allowed if the signal quality of the target cell, e.g., measured in terms of RSRP, RSRQ, or SINR, is above a threshold. Such threshold can be configurable from the network side. In addition or as an alternative, such additional conditions could require that premature triggering of execution of the CHO is allowed if the signal quality of the target cell, e.g., measured in terms of RSRP, RSRQ, or SINR, is expected to remain above a threshold. Such threshold and an associated time interval for which the signal quality shall remain above the threshold could be configurable from the network side. In addition or as an alternative, such additional conditions could be based on predicted signal quality of the target cell and of the source cell. For example, such prediction could indicate whether the entry condition of the first condition is expected to be still satisfied and the end of the time interval TTT, and premature triggering of execution of the CHO could be allowed if the entry condition is expected to continue being fulfilled until the end of the time interval TTT. In some cases, the premature triggering of execution of the CHO could also be based on defining an additional shorter TTT. For example, the above-mentioned TTT could be 200 ms and the additional shorter TTT could be 100 ms. In that case, the first condition could be deemed to be fulfilled if the entry condition continues to be fulfilled until the end of the additional short TTT and execution of the CHO prematurely triggered if also the second condition related to the data buffer is fulfilled at the end of the additional short TTT. Otherwise, the first condition and the second condition could be re-evaluated at the end of the longer TTT.

In the above examples, one or more data buffers are considered when triggering execution of the reconfiguration procedure. Such data buffer may correspond to an UL buffer or to a DL buffer. Further, such data buffer may reside on any of various protocol layers, e.g., on a PDCP layer or an RLC layer. Further, such data buffer may be associated with a logical channel, a logical channel group, a set of logical channel groups, or a network slice. Accordingly, in the illustrated concepts multiple kinds of data buffers can be considered as alternatives or in combination.

For evaluation of the above-mentioned condition(s) related to the data buffer(s), information on the actual status or at least expected status of the data buffer(s) is needed. In some cases, such information may be readily available. For example, when at block 208 of FIG. 2 the UE 10 considers the condition(s) related to the UL buffer, this data buffer is locally maintained by the UE 10 itself. Accordingly, the information on the current status of the UL buffer is typically directly available in the entity considering the respective condition. Similarly, when at block 303 of FIG. 3 the serving AN 101-1 considers the condition(s) related to the DL buffer, this data buffer is locally maintained by the serving AN 101-1 itself. Accordingly, the information on the current status of the DL buffer is typically directly available in the entity considering the respective condition. However, in some situations, the UE 10 could need information on the status of the UL buffer expected in the future, and/or information on the current or future status of the DL buffer, which is maintained at the serving AN 101-1. Similarly, the serving AN 101-1 could need information on the status of the DL buffer expected in the future, and/or information on the current or future status of the UL buffer, which is maintained at the UE 10. As will be further explained below, such information can be provided on the basis of signaling between the UE 10 and the serving access node 101-1, e.g., based on transmission of DL buffer status reports by the serving AN 101-1 and/or transmission of UL buffer status reports by the UE 10. In addition or as an alternative, such information could be provided on the basis of a prediction model, e.g., using machine learning or artificial intelligence.

For example, the UE 10 could use the status of the UL buffer as observed in the past to predict the status of the UL buffer in the future. Similarly, the serving access node 101-1 could use the status of the DL buffer as observed in the past to predict the status of the DL buffer in the future. Further, the UE 10 could indicate the current or predicted future status of the UL buffer to the serving AN 101-1 and/or the serving AN 101-1 could indicate the current or predicted future status of the DL buffer to the UE 10. Further, the UE 10 could use information collected from the serving AN 101-1 to estimate the current status of the DL buffer or predict the future status of the DL buffer. Similarly, the serving AN 101-1 could use information collected from the UE 10 to estimate the current status of the UL buffer or predict the future status of the UL buffer. Such prediction may also consider known or learned traffic characteristics of the UP data transmitted between the UE 10 and the serving AN 101-1. For example, the UE 10 such known or learned traffic characteristic could involve that, after transmission of a burst of DL data, there will be no further transmission of DL data for a certain time, e.g., for a number of slots, frames, subframes, or modulation symbols. In some cases, the predictions could also be assisted by subjecting the transmissions of UL data to certain rules which are known to the serving AN 101-1, e.g., configured by the serving AN 101-1, or by subjecting the transmissions of DL data to certain rules which are known to the UE 10. In some cases, such known or learned traffic characteristic could also be derived from information provided from higher protocol layers, e.g., through one or more APIs (Application Programming Interfaces).

In some scenarios, information on the status of an UL data buffer may thus be obtained by the UE monitoring the status of the current data already available to be transmitted, i.e., the data pending in the UL buffer for transmission. Additionally or alternatively, the UE may consider predictions regarding the UL buffer.

Such prediction by the UE may for example be based on arrival times of data in the UL buffer, e.g., as observed by the UE over an observation time interval in the past. Such observation time interval may be configured from the network side.

In addition or as an alternative, such prediction by the UE may involve making a binary query. In such binary query, the UE may determine whether or not there will be any data arriving in the UL buffer within a given time period. For example, after the above-mentioned first condition for triggering execution of the CHO is fulfilled, the UE could predict whether any new data will arrive in the UL buffer within a configurable time period Tb. The time period Tb could for example be chosen based on a time which is typically needed for connecting to a new cell, based on a timer for assessing successful completion of an RRC reconfiguration procedure, such as the T304 timer specified for the 5G NR technology, based on typical time scales of RLF events, or the like.

In addition or as an alternative, such prediction by the UE may involve prediction of arrival times of data in the UL buffer. In this case, the UE may predict the exact time at which data will arrive in the UL buffer. For example, after the above-mentioned first condition for triggering execution of a CHO is fulfilled, the UE could predict that the next times data will arrive in the UL buffer will be at N subsequent time instances t1<t2< . . . tN, with N being configurable. This information can be used to determine the time instance and time duration when the UL buffer can expected to be empty. The UE may then determine whether there is a suitable time period over which the UL buffer is expected to remain empty and which allows for completing execution of a CHO. This may for example involve comparing durations of time periods over which the UL buffer is expected to remain empty to a typical time duration associated with successfully completing execution of a CHO, e.g., derived from a timer for assessing successful completion of an RRC reconfiguration procedure, such as the T304 timer specified for the 5G NR technology.

In addition or as an alternative, such prediction by the UE may involve predicting an amount of data arriving in the UL buffer and/or sizes of data packets arriving in the UL buffer.

In addition or as an alternative, such prediction by the UE may involve predicting how much data, e.g., in units of bytes, data packets, or the like, will arrive in the UL buffer per given time interval. For example, by predicting the amount of data expected to arrive until a future time instance or within a given time period, the UE could determine whether it will be possible to meet the condition related to the data buffer. If this is not the case, the UE could decide to refrain from making potentially unsuccessful attempts to meet the second condition by delaying triggering execution of a CHO. For example, if the UE predicts that a large amount data will arrive in the UL data buffer soon after the first condition is met, the UE could determine that will not be possible to perform a CHO under the further condition that the UL buffer is empty and decide to trigger execution of a CHO without any attempt to first empty the UL buffer by delaying execution of a CHO. In this way, it could be avoided that excessive delaying of a CHO results in RLF. Otherwise, if the UE predicts that the amount of data expected to arrive is small, it could proceed as described above and delay triggering execution of a CHO with the aim of first emptying the UL buffer.

In addition or as an alternative, such prediction by the UE may involve predicting the amount of data in the UL buffer at a certain future time. For example, the UE could predict the amount of data in the UL buffer at a future time instance by considering the data arrival and departure processes, in particular data arrival and departure processes as observed in the past and data arrival and departure processes as predicted to occur in the future. This may also involve that the UE is informed from the network side about UL grants for transmission of the UL data on the wireless connection and/or that the UE predicts upcoming UL grants which can be used for the transmission of the UL data. Based on such UL grants, the UE can estimate a data rate for transmission of UL data from the UL buffer and thereby predict future data departure processes. By combining this information with information regarding data arrival in the UL buffer, e.g., estimated as described above, the UE can estimate the amount of data in the UL buffer at a future time instance. Using this information, the UE may in turn identify a suitable future time period over which the UL buffer is expected to remain empty and which allows for completing execution of a CHO.

As mentioned above, the UE may also consider information on one or more DL buffers, which are maintained on the network side. For this purpose, the UE may for example consider explicit buffer status signaled from the network, e.g., in DL buffer status reports from the serving access node. For example, such DL buffer status report could be included in the CHO command sent to the UE. The UE could then estimate, based on the last fill level of the DL buffer indicated by the DL buffer status report and for example additionally considering the amount of DL data as received by the UE after the DL buffer status report, whether or when the DL buffer is expected to be empty. In some cases, providing only the last fill level of the DL buffer could be insufficient for accurately estimating the status of DL buffer at the time when considering whether to trigger execution of a CHO. For example, it may occur that new data arrives in the DL buffer after the UE received the last DL buffer status report included in the CHO command. This may be addressed by supplementing the DL buffer status report with a prediction concerning future development of the fill level of the DL buffer, e.g., based on a prediction model maintained and continuously updated by the serving access node of the UE. As a result, the UE can estimate the expected status of the DL buffer in a more accurate manner by considering the last reported fill level of the DL buffer, the predicted development of the fill level of the DL buffer, and the amount of DL data received by the UE.

In addition or as an alternative, the serving access node could use L1 (layer 1) signaling to provide the UE with one or more DL buffer status reports indicating the current fill level of the DL buffer and/or predictions concerning future development of the fill level of the DL buffer. For example, such DL buffer status reports could be included in downlink control information (DCI) transmitted from the serving access node to the UE on a Physical Downlink Control Channel (PDCCH).

In addition or as an alternative, the UE could estimate the status of the DL buffer based on scheduling information provided from the serving access node to the UE. For example, the UE could detect that it did not receive DL grants for a certain time interval and deduce therefrom that the DL buffer is empty. Further, the serving access node could explicitly indicate to the UE, e.g., using DCI, that the UE will not receive any DL grant for a given time period. Based on such information, the UE can decide whether there is an upcoming time period in which the UE will not be scheduled for transmissions of DL data and which allows for completing execution of a CHO.

In addition or as an alternative, the UE may predict the future status of the DL buffer based on observations made in the past. In particular, similar to the above prediction of the status of the UL buffer, such prediction could involve predicting times of arrival of data in the DL buffer, making a binary query for determining whether or not any data is expected to arrive in the DL buffer within a given time period. In addition or as an alternative, such prediction may involve predicting an amount of data expected to arrive at the DL buffer within a given time period. In each case, such prediction may be based on an initial prediction made on the network side, e.g., by the serving access node, which is then reported to the UE.

In some scenarios, the serving access node may obtain information on the status of an DL data buffer may thus be obtained by the serving access node monitoring the status of the current data already available to be transmitted, i.e., the data pending in the DL buffer for transmission. Additionally or alternatively, the serving access node may consider predictions regarding the DL buffer.

Such prediction by the serving access node may for example be based on arrival times of data in the DL buffer, e.g., as observed by the serving access node over an observation time interval in the past. Such observation time interval may be configurable.

In addition or as an alternative, such prediction by the serving access node may involve making a binary query. In such binary query, the serving access node may determine whether or not there will be any data arriving in the UL buffer within a given time period. For example, after signal-quality based conditions for triggering execution of a HO are fulfilled, the serving access node could predict whether any new data will arrive in the DL buffer within a configurable time period Tb. The time period Tb could for example be chosen based on a time which is typically needed for connecting the UE to a new cell, based on a timer for assessing successful completion of an RRC reconfiguration procedure, such as the T304 timer specified for the 5G NR technology, based on typical time scales of RLF events, or the like.

In addition or as an alternative, such prediction by the serving access node may involve prediction of arrival times of data in the DL buffer. In this case, the serving access node may predict the exact time at which data will arrive in the DL buffer. For example, after signal-quality based conditions for triggering execution of a HO are fulfilled, the serving access node could predict that the next times data will arrive in the DL buffer will be at N subsequent time instances t1<t2< . . . tN, with N being configurable. This information can be used to determine the time instance and time duration when the DL buffer can expected to be empty. The serving access node may then determine whether there is a suitable time period over which the DL buffer is expected to remain empty and which allows for completing execution of the HO. This may for example involve comparing durations of time periods over which the DL buffer is expected to remain empty to a typical time duration associated with successfully completing execution of the HO, e.g., derived from a timer for assessing successful completion of an RRC reconfiguration procedure, such as the T304 timer specified for the 5G NR technology.

In addition or as an alternative, such prediction by the serving access node may involve predicting an amount of data arriving in the DL buffer and/or sizes of data packets arriving in the DL buffer.

In addition or as an alternative, such prediction by the serving access node may involve predicting how much data, e.g., in units of bytes, data packets, or the like, will arrive in the DL buffer per given time interval. For example, by predicting the amount of data expected to arrive until a future time instance or within a given time period, the serving access node could determine whether it will be possible to meet the condition related to the data buffer. If this is not the case, the serving access node could decide to refrain from making potentially unsuccessful attempts to meet the condition related to the data buffer by delaying triggering execution of a HO. For example, if the serving access node predicts that a large amount data will arrive in the DL data buffer soon after the signal-quality based conditions are met, the serving access node could determine that will not be possible to perform the HO under the further condition that the DL buffer is empty and decide to trigger execution of the HO without any attempt to first empty the DL buffer by delaying execution of the HO. In this way, it could be avoided that excessive delaying of a HO results in RLF. Otherwise, if the serving access node predicts that the amount of data expected to arrive is small, it could proceed as described above and delay triggering execution of a HO with the aim of first emptying the DL buffer.

In addition or as an alternative, such prediction by the serving access node may involve predicting the amount of data in the DL buffer at a certain future time. For example, the serving access node could predict the amount of data in the DL buffer at a future time instance by considering the data arrival and departure processes, in particular data arrival and departure processes as observed in the past and data arrival and departure processes as predicted to occur in the future. Here, the serving access node may also consider ongoing scheduling processes for transmission of DL data to the UE. By combining this information with information regarding data arrival in the DL buffer, e.g., estimated as described above, the serving access node can estimate the amount of data in the DL buffer at a future time instance. Using this information, the UE may in turn identify a suitable future time period over which the DL buffer is expected to remain empty and which allows for completing execution of a HO.

As mentioned above, the serving access node may also consider information on one or more UL buffers, which are maintained by the UE. For this purpose, the serving access node may for example consider explicit buffer status signaled from the network, e.g., in UL buffer status reports from the UE. The serving access node could then estimate, based on the last fill level of the UL buffer indicated by the UL buffer status report and for example additionally considering the amount of UL data as received from the UE after the UL buffer status report, whether or when the UL buffer is expected to be empty. In some cases, providing only the last fill level of the UL buffer could be insufficient for accurately estimating the status of UL buffer at the time when considering whether to trigger execution of a HO. For example, it may occur that new data arrives in the UL buffer after the UE sent the last UL buffer status report. This may be addressed by supplementing the UL buffer status report with a prediction concerning future development of the fill level of the UL buffer, e.g., based on a prediction model maintained and continuously updated by the UE. As a result, the serving access node can estimate the expected status of the UL buffer in a more accurate manner by considering the last reported fill level of the UL buffer, the predicted development of the fill level of the UL buffer, and the amount of UL data received from the UE.

The UL buffer status reports indicating the current fill level of the UL buffer and/or predictions concerning future development of the fill level of the UL buffer could be provided using L1 signaling. For example, such UL buffer status reports could be included in uplink control information (UCI) transmitted from the UE to the serving access node on a Physical Uplink Control Channel (PUCCH). Alternatively or in addition, the UL buffer status reports could be included in MAC (Medium Access Control) signaling, e.g., in headers of data packets conveying UL data from the UE.

In addition or as an alternative, the serving access node could estimate the status of the UL buffer based on scheduling requests received from the UE. For example, the serving access node could detect that it did not receive scheduling requests from the UE for a certain time interval and deduce therefrom that the UE's UL buffer is empty. Further, the UE could explicitly indicate to the serving access node, e.g., using UCI, that the UE will not send any scheduling request for a given time period. Based on such information, the serving access node can decide whether there is an upcoming time period in which the UE will not send UL data and which allows for completing execution of a HO.

In addition or as an alternative, the serving access node may predict the future status of the UL buffer based on observations made in the past. In particular, as mentioned above, such prediction could involve predicting times of arrival of data in the UL buffer, making a binary query for determining whether or not any data is expected to arrive in the UL buffer within a given time period. In addition or as an alternative, such prediction may involve predicting an amount of data expected to arrive at the UL buffer within a given time period. In each case, such prediction may be based on an initial prediction made by the UE, e.g., by the serving access node, which is then reported to the serving access node.

In the following, an example of a prediction model to be utilized on the UE side will be described in more detail. The prediction model may be based on machine learning and may be implemented by a software function. In some cases, corresponding software code may be provided from the network side, e.g., by causing the UE to download the software code or by pushing the software code to the UE. In addition or as an alternative, the software function may be configurable from the network side, e.g., using APIs that are exposed by the UE to the network, so that a network node, e.g., the serving access node 101-1 or the above-mentioned control node 130, is able to configure the prediction model. In some scenarios, the UE could indicate corresponding capability information to the network. For example, the capability information could indicate to the network that the UE can download or receive a prediction model from the network. The capability information may be based various software and hardware aspects of the UE, availability of sensors, or the like. The capability information may indicate that the UE can perform a prediction. For example, the capability information could indicate that the UE is capable to predict whether new data is expected to arrive in the DL data buffer and/or in the UL buffer in a given time interval. The capability information may indication prediction capabilities of the UE using various levels of granularity. For example, in a coarse level, the capability information could indicate that the UE is provided with a prediction model. On a finer level, the capability information could indicate a type of the prediction model, e.g., out of a list of prediction model types defined in a standard. On a further level, the capability information could indicate which kinds of predictions the prediction model can perform and/or what kinds of input the prediction model can take into account.

In some cases, at least a part of the prediction model could also be preconfigured in the UE, e.g., based on standardization or in a proprietary manner.

When the prediction model is implemented at the UE, it may be further configured from the network side, e.g., by the serving access node 101-1 or the control node 130. Such configuration may for example involve defining parameters of the prediction model.

In some scenarios, the prediction model could be based on a neural network (NN) having L layers, where each layer, identified by a layer index i, has Nᵢ nodes, and each node, identified by node index j and layer index i, has a set of weights W_{j,i}. Training of the prediction model could be based on using previously recorded datasets assembling examples of inputs and the corresponding observed or expected outputs. In some scenarios, the prediction model could be based on a Recurrent Neural Network (RNN). Unlike feedforward NNs, an RNN has feedback connections that work as a memory state. This memory state allows the RNN to preserve statistical characteristics of its input data across time steps, which allows for efficiently deriving predictions from time series input data. For example, the network feeds the RNN with a feature vector related to the amount of data that arrived in the data buffer over a past sequence of measurement time intervals of length T, the RNN will be able to output the expected amount of data that will respectively arrive in the next upcoming time intervals of length T. To train the RNN, the UE could use a backpropagation through time (BPTT) method. A Long short-term memory (LSTM) architecture is an example of an RNN that could be used in the prediction model implemented by the UE.

In some scenarios, training of the prediction model may involve trying to find hidden patterns in the input data without having any prior knowledge of such patterns, e.g., without having dedicated training sets indicating the output the prediction model should provide for a given input. A possible way to detect such hidden patterns is to utilize an algorithm referred to as “K-means”. A K-means algorithm tries to find clusters only based on unlabeled input and a predefined number of clusters. For example, using a K-means algorithm, patterns of amounts of data in the data buffer could be clustered according to the likelihood of new data arriving in the data buffer in the next upcoming time intervals of length T.

The general structure of the prediction model, e.g., usage of a NN having a number of L layers, Ni nodes per layer, and sets of weights W_{j,i} per node, could be preconfigured or part of the downloaded or otherwise received software function, whereas the specific values of L, Ni, and W_{j,i} are set by the network as part of the further configuration process. Alternatively, the predication model could be based on a Random Forest model, and the further configuration process could involve that the network sets a number of estimators of the Random Forest model, also denoted as “trees in the forest”, a depth of each tree, and a threshold for each leaf of the trees.

In the illustrated example, the prediction model collects information about data transmitted to and/or from the UE. The information may be collected per application, per service, and/or per bearer. The information is then used to train the prediction model, with the aim of enabling the prediction model to perform one or more predictions, e.g., related to the status of the UL buffer and/or the DL buffer, or related to arrival and/or departure of data from the UL buffer and/or DL buffer. For example, one kind of such prediction could involve predicting when a data packet of a certain application, service, or bearer will be transmitted and optionally also the size of the data packet. Another type of such prediction could involve predicting whether the UL buffer and/or the DL buffer will be empty at a certain future time instance or during a certain future time interval.

As an example for illustrating operation of the prediction model, FIG. 7 illustrates a periodic burst of data that arrives in the data buffer. A top part of FIG. 7 illustrates the arrival of data over the time (t), as observed over a sequence of time steps of length T. Each block plotted for a given time step corresponds to a certain amount of arriving data, e.g., 10 kB. The burst has a duration of 80 ms and repeats each 110 ms.

In this example, an input data element, also denoted as “feature vector”, used in the prediction model is assumed to be represented by a vector of size K=10, where the k-th element, counted from left to the right in the illustration, corresponds to the amount of data that arrived at past time t0−(K−k)*T, where t0 denotes the current time. An output data element of the prediction model may in turn be a vector of size M=6, where the m-th element corresponds to the amount of data that is expected to arrive in the UE buffer at a future time t0+m*T. The prediction model may be trained by for example using supervised learning. For this purpose, the UE could record, over time, training data in the form of multiple snapshots of a sliding window of size S=K+M=16, e.g., like illustrated in the bottom part of FIG. 7. In such sliding window, the s-th element, from the left to the right in the illustration and with 0<s<S, corresponds to the amount of data that arrived at time (16−s)*T before end of the sliding window. During the learning process, each stored sliding window can be split into two vectors, where one vector of size I=10 represents a given training input and the remaining vector of size J=6 represents the observed data, which should be predicted by the trained prediction model. Based on the predictions from the training input and the corresponding observed data, the prediction model is adapted, e.g., by adapting weights. After having trained the prediction model by feeding it with the above-mentioned training data, the UE can use the prediction model use it in an online mode, with input vectors of size K=10 in order to predict the expected amount of data that will arrive in the next M=6 instants of time. It is however also possible to retrain the prediction model from time to time or to continue training of the prediction model also in the online mode. Further, it is noted that the above values of K, M, and T are merely exemplary and that other values could be used as well.

In the following, an example of a prediction model to be utilized on the network side, in particular in the serving access node, will be described in more detail. The prediction model may be based on machine learning and may be implemented by a software function. In some cases, corresponding software code may be provided from a control node of the wireless communication network, such as the above-mentioned control node 130, e.g., by causing the serving access node to download the software code or by pushing the software code to the serving access node. In addition or as an alternative, the software function may be configurable, e.g., using APIs that are exposed to other nodes of the wireless communication network, so that for example the above-mentioned control node 130 is able to configure the prediction model. In some scenarios, the serving access node could indicate corresponding capability information to the other nodes of the wireless communication network. For example, the capability information could indicate that the serving access node can download or receive a prediction model. The capability information may be based various software and hardware aspects of the serving access node, availability of sensors, or the like. The capability information may indicate that the serving access node can perform a prediction. For example, the capability information could indicate that the serving access node is capable to predict whether new data is expected to arrive in the DL data buffer and/or in the UL buffer in a given time interval. The capability information may indication prediction capabilities of the serving access node using various levels of granularity. For example, in a coarse level, the capability information could indicate that the serving access node is provided with a prediction model. On a finer level, the capability information could indicate a type of the prediction model, e.g., out of a list of prediction model types defined in a standard. On a further level, the capability information could indicate which kinds of predictions the prediction model can perform and/or what kinds of input the prediction model can take into account.

In some cases, at least a part of the prediction model could also be preconfigured in the serving access node, e.g., based on standardization or in a proprietary manner.

When the prediction model is implemented at the serving access node, it may be further configured from the network side, e.g., by the serving access node 101-1 or the control node 130. Such configuration may for example involve defining parameters of the prediction model.

The prediction model used by the serving access node can be UE specific. For example, the prediction model could use a set of RNN weights which is specific for each UE served by the serving access node. Further, the prediction model could be service specific, e.g., by using different sets of RNN weights for URLLC services, and eMBB services, or the like. In some scenarios, different access nodes, such as the above-mentioned access nodes 101-1 and 101-2, could share the prediction model, e.g., by using the same weights. In other cases, different access nodes could utilize individually trained prediction model. Accordingly, the prediction model could be access node specific. In the case the prediction model being shared by multiple access nodes, the training of the prediction model could be performed in a centralized node, such as the above-mentioned control node, based on training data provided by the multiple access nodes. Alternatively, the training of the shared prediction model could be performed in a cooperative manner. For example, such cooperative training could involve that each of the access nodes obtains a common initial configuration of the prediction model from a centralized node such as the above-mentioned control node 130, retrains the prediction model starting from the initial configuration and using training data collected by the respective access node, and then provides the configuration learnt from the retraining to the centralized node, which aggregates the different learnt configurations to a common configuration to be applied by the access nodes. In other variants, sharing of the prediction model could also involve that one access node provides its learnt configuration of the prediction model to another access node.

In some scenarios, the prediction model may be based on an NN having L layers, where each layer, identified by a layer index i, has Ni nodes, and each node, identified by node index j and layer index i, has a set of weights W_{j,i,}. Training of the prediction model could be based on using previously recorded datasets assembling examples of inputs and the corresponding observed or expected outputs. In some scenarios, the prediction model could be based on anRNN. Unlike feedforward NNs, an RNN has feedback connections that work as a memory state. This memory state allows the RNN to preserve statistical characteristics of its input data across time steps, which allows for efficiently deriving predictions from time series input data. For example, the network feeds the RNN with a feature vector related to the amount of data that arrived in the data buffer over a past sequence of measurement time intervals of length T, the RNN will be able to output the expected amount of data that will respectively arrive in the next upcoming time intervals of length T. To train the RNN, the serving access node could use a BPTT method. An LSTM architecture is an example of an RNN that could be used in the prediction model implemented on the network side.

In some scenarios, training of the prediction model may involve trying to find hidden patterns in the input data without having any prior knowledge of such patterns, e.g., without having dedicated training sets indicating the output the prediction model should provide for a given input. A possible way to detect such hidden patterns is to utilize an algorithm referred to as “K-means”. A K-means algorithm tries to find clusters only based on unlabeled input and a predefined number of clusters. For example, using a K-means algorithm, patterns of amounts of data in the data buffer could be clustered according to the likelihood of new data arriving in the data buffer in the next upcoming time intervals of length T.

The general structure of the prediction model, e.g., usage of a NN having a number of L layers, Nᵢ nodes per layer, and sets of weights W_{j,i} per node, could be preconfigured or part of the downloaded or otherwise received software function, whereas the specific values of L, Nᵢ, and W_{j,i} are set by the network as part of the further configuration process. Alternatively, the predication model could be based on a Random Forest model, and the further configuration process could involve that the network sets a number of estimators of the Random Forest model, also denoted as “trees in the forest”, a depth of each tree, and a threshold for each leaf of the trees.

In the illustrated example, the prediction model collects information about data transmitted to and/or from the UE. The information may be collected per application, per service, and/or per bearer. The information is then used to train the prediction model, with the aim of enabling the prediction model to perform one or more predictions, e.g., related to the status of the UL buffer and/or the DL buffer, or related to arrival and/or departure of data from the UL buffer and/or DL buffer. For example, one kind of such prediction could involve predicting when a data packet of a certain application, service, or bearer will be transmitted and optionally also the size of the data packet. Another type of such prediction could involve predicting whether the UL buffer and/or the DL buffer will be empty at a certain future time instance or during a certain future time interval.

An input data element of the prediction model, i.e., a feature vector, can for example be represented by a vector of size P, where the p-th element corresponds to the amount of data that arrived at past time t0−(P−p)*T, where t0 denotes the current time and T represents a given time step. Another example of a feature vector could be a vector of size Q, where the q-th element represents a mean periodicity of packets of size q*R, where R is a given standard packet size.

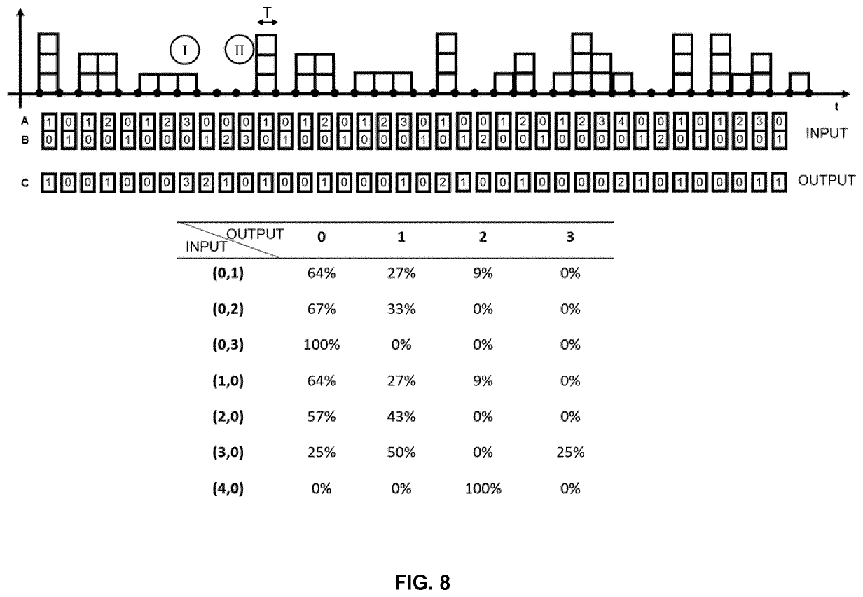

As an example for illustrating operation of the prediction model implemented on the network side, FIG. 8 illustrates an example of data arrival in the data buffer considered by the prediction model and corresponding input data and output data of the prediction model. A top part of FIG. 8 illustrates the arrival of data over the time (t), as observed over a sequence of time steps of length T. Each block plotted for a given time step corresponds to a certain amount of arriving data, e.g., 10 kB. Below that, rows A and B illustrate the input data of the prediction model at the corresponding time instants. Row C illustrates the output of the prediction model. The values given in row A correspond to the number of consecutive time steps in which data arrived in the data buffer. The values given in row B correspond to the number of consecutive time steps in which no data arrived in the data buffer. As can be seen, for a given time step, either the value in row A or the value in row B is zero, because either data arrived or not. Circles marked with “I” denote two exemplary time steps. At time step “I”, data has been arriving for 3 consecutive instants of time steps, thus the corresponding value in row A is “3”, and the corresponding value in row “B” is “0”. Time step “II”, is the third consecutive time step during which no data arrived in the data buffer. Accordingly, the corresponding value in row A is “0” and the corresponding value in row B is “3”.

The values in row C, which correspond output of the prediction model, correspond to the estimated number of time steps during which no data is expected to arrive in the data buffer. For example, after time step “I”, new data is expected to arrive after three consecutive time steps without arrival of data. After time step “II”, new data is expected to arrive already in the next time step.

In order to train the prediction model, the serving access node network may use recorded data corresponding to the data of the above-mentioned rows A, B, a end C. For example, the recorded data can be processed in order to produce a table as shown in FIG. 8. By way of example, the values in the table of FIG. 8 are based on values as shown in rows A, B, and C of FIG. 8. The table relates input values to probabilities of observing a certain output value. Specifically, the value associated with input X and observed output Y represents the probability of new data to arriving in Y time steps given that the input is X. In the illustrated exemplary data, the input (0,3) appears only once in the sequence of rows A and B, and the associated output was 3. Thus, in the table, for input (0,3) the probability of output 3 is 100%, while the other outputs have probability equal to 0%. The input (3,0) appears four times in the sequence of rows a and B, with the associated outputs being 3, 1, 0, and 1. Thus, for input (3,0), the probability of outputs 0, 1, 2, and 3 are 25%, 50%, 0% and 25%, respectively. Such probabilities can then be used for adapting the prediction model in the training process. After having trained the prediction model, the serving access node can use the prediction model it in an online mode, to predict from an observed input the probability of new data to arrive after Y time steps into the future. It is however also possible to retrain the prediction model from time to time or to continue training of the prediction model also in the online mode.

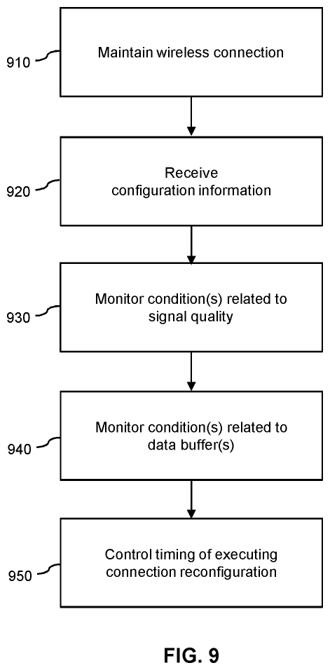

FIG. 9 shows a flowchart for illustrating a method, which may be utilized for implementing the illustrated concepts. The method of FIG. 9 may be used for implementing the illustrated concepts in a wireless communication device for operation in a wireless communication network. The wireless communication device may for example correspond to the above-mentioned UE 10 or to any of the above-mentioned access nodes 101-1, 101-2.

If a processor-based implementation of the wireless communication device is used, at least some of the steps of the method of FIG. 9 may be performed and/or controlled by one or more processors of the wireless communication device. Such wireless communication device may also include a memory storing program code for implementing at least some of the below described functionalities or steps of the method of FIG. 9.

At step 910, the wireless communication device maintains a wireless connection. In some scenarios, the wireless communication device may be a UE, such as the above-mentioned UE 10, and maintain the wireless connection to the wireless communication network, e.g., to an access node of the wireless communication network, such as any one of the above-mentioned access nodes 101-1, 101-2. In other scenarios, the wireless communication device could be an access node of the wireless communication network, such as any of the above-mentioned access nodes 101-1, 101-2, and maintain the wireless connection to a UE, e.g., to the above-mentioned UE 10.

At step 920 the wireless communication device may receive configuration information. The wireless communication device may receive the configuration information from a node of the wireless communication network. For example, the above mentioned UE 10 could receive at least a part of such configuration information from its serving access node 101-1. Further, at least a part of the configuration information received from the serving access node 101-1 to the UE 10 could be provided by the control node 130. Further, the above-mentioned access nodes 101-1, 101-2 could receive at least a part of such configuration information from another node of the wireless communication network, such as the above-mentioned control node 130. In some cases, at least a part of the configuration information may be received in a procedure for establishing the wireless connection, e.g., in an RRC connection setup procedure. In some cases, at least a part of the configuration information may be received in a procedure for reconfiguration of the wireless connection, e.g., in an RRC connection reconfiguration procedure. In some cases, at least a part of the configuration information may be received in a handover command, such as in the above-mentioned CHO command 207.

At step 930, the wireless communication device may monitor one or more conditions related to signal quality. For example, for purposes of controlling reconfiguration of the wireless connection in a handover from a source cell to a target cell or to one of multiple candidate target cells, the wireless communication device could monitor signal quality of the source cell and/or signal quality of the target cell e.g., in terms of RSRP; RSRQ, or SINR.

At least one of the one or more conditions monitored at step 930 may on indicated by the configuration information received at step 920.

At step 940, the wireless communication device monitors one or more conditions related to one or more data buffers for data to be transmitted on the wireless connection maintained by the wireless communication device. The one or more data buffers may include a data buffer for data to be transmitted in an DL direction, such as the above-mentioned DL buffer(s). Alternatively or in addition, the one or more data buffers may include a data buffer for data to be transmitted in a UL direction, such as the above mentioned UL buffer(s). The one or more data buffers may for example be defined on a PDCP layer and/or on an RLC layer of a protocol stack of the wireless connection.

In some scenarios, the one or more conditions may include at least one condition which is based on determining when at least one of the one or more data buffers is empty. In some cases, such determination may be based on reports received by the wireless communication device, e.g., if the considered at least one data buffer is not maintained by the wireless communication device itself, but at a remote end of the wireless connection. In such cases, the wireless communication device may receive one or more reports indicating a status of the at least one data buffer and estimate based on the received one or more reports when the at least one of the one or more data buffers is empty. For example, if in CHO processes like illustrated in FIG. 2 the UE 10 controls triggering execution of the CHO based on the status of a DL buffer maintained by the serving AN 101-1, the UE 10 may determine from one or more reports from the serving AN 101-1 when the DL buffer is empty or will be empty. Similarly, if in network triggered HO processes like illustrated in FIG. 3 the serving access node 101-1 controls triggering execution of the HO based on the status of a UL buffer maintained by the UE 10, the serving AN 101-1 may determine from one or more reports from the serving UE 10 when the UL buffer is empty or will be empty.

Alternatively or in addition, the wireless communication device may estimate based on a machine learning model when the at least one of the one or more data buffers is empty. For example, if in CHO processes like illustrated in FIG. 2 the UE 10 controls triggering execution of the CHO based on the status of a DL buffer maintained by the serving AN 101-1, the UE 10 may determine based on a machine learning model, such as the prediction model explained in connection with FIG. 7, when the DL buffer is empty or will be empty. Similarly, if in CHO processes like illustrated in FIG. 2 the UE 10 controls triggering execution of the CHO based on the status of a UL buffer maintained by the UE 10 itself, the UE 10 may predict based on a machine learning model, such as the prediction model explained in connection with FIG. 7, when the UL buffer will be empty. Further, if in network triggered HO processes like illustrated in FIG. 3 the serving access node 101-1 controls triggering execution of the HO based on the status of a DL buffer maintained by the serving AN 101-1, the serving AN 101-1 may determine based on a machine learning model, such as the prediction model explained in connection with FIG. 8, when the UL buffer is empty or will be empty. Further, if in network triggered HO processes like illustrated in FIG. 3 the serving access node 101-1 controls triggering execution of the HO based on the status of a DL buffer maintained by the serving AN 101-1, the serving AN 101-1 may predict based on a machine learning model, such as the prediction model explained in connection with FIG. 8, when the DL buffer will be empty.

At least one of the one or more conditions monitored at step 940 may be indicated by the configuration information received at step 920.

At step 950, based on the one or more conditions monitored at step 940, the wireless communication device controls timing of executing a reconfiguration of the wireless connection. The reconfiguration may correspond to or be part of a RRC reconfiguration procedure, i.e., be based on RRC signaling to or from the wireless communication device.

In some scenarios, a target time for executing the reconfiguration may be based on at least one further condition, e.g., as for example monitored at step 930. In such case, the controlling the timing of executing the reconfiguration of step 950 may involve controlling whether to execute the reconfiguration after the target time, i.e., whether to delay the execution of the reconfiguration. The target time may for example be defined by the above-mentioned TTT.

Accordingly, the at least one further condition may be related to signal quality of the wireless connection and/or to signal quality of multiple cells of the wireless communication network. For example, if the reconfiguration is a CHO or a HO, the at least one further condition may be based on a difference of signal quality between a source cell and a target cell of the CHO or HO. The target cell may be selected among multiple candidate target cells, e.g., based on the respective signal quality of each candidate target cell. More specifically, the at least one further condition could require that, the difference of signal quality between the source cell and the target cell exceeds a threshold plus a margin, and after that the difference of signal quality remains above the threshold until the target time.

In some scenarios, the reconfiguration may involve a handover of the wireless connection from a source cell to a target cell, such as the above-mentioned CHO processes as for example explained in connection with FIG. 2 or the above-mentioned HO processes as for example explained in connection with FIG. 3. In such cases, the controlling of the timing of step 950 could also include selecting the target cell. For example, the target cell could be selected among multiple candidate target cells. This may be accomplished with the aim that the one or more conditions related to the data buffer are met when executing the handover to the selected target cell, such as in the example of FIG. 5.

If the reconfiguration of the wireless connection involves a handover of the wireless connection from a source cell to a target cell the one or more conditions monitored at step 950 may include at least one condition which is further related to signal quality of the target cell. In addition or as an alternative, the one or more conditions may include at least one condition which is further related to signal quality of the source cell.

In some scenarios, the reconfiguration may involve modification of a carrier aggregation configuration of the wireless connection, e.g., by removal or change of a component carrier.

In some scenarios, controlling the timing of executing the reconfiguration at step 950 may involve triggering execution of the reconfiguration. For example, in CHO processes as explained in connection with FIG. 2 the UE 10 may trigger execution of the CHO if the condition(s) related to the data buffer and other required conditions are met. Similarly, in HO processes as explained in connection with FIG. 3 the serving access node 101-1 may trigger execution of the HO if the condition(s) related to the data buffer and other required conditions are met.

In some scenarios, controlling the timing of executing the reconfiguration at step 950 may involve sending information for controlling execution of the reconfiguration. For example, in CHO processes as explained in connection with FIG. 2 the UE 10 may send reports concerning the considered data buffer(s) to the serving access node 101-1, and in response the serving access node 101-1 may adapt the scheduling of the UE 10 so that emptying of the data buffer is expedited and the CHO can be executed earlier. Further, in HO processes as explained in connection with FIG. 3 the serving access node 101-1 may control the timing by sending the HO command to the UE 10, e.g., by controlling when to send the HO command.

In some scenarios, the wireless communication device may control the timing of executing the reconfiguration based on received configuration information, e.g., as received at step 920. For example, such configuration information could indicate the one or more conditions related to the one or more data buffers. Further, such configuration information could indicate additional parameters, e.g., timer values, threshold values, parameters of a machine learning model to be applied for making predictions concerning the one or more data buffers, and/or parameters of a machine learning model to be applied for making predictions concerning signal qualities related to the wireless connection.

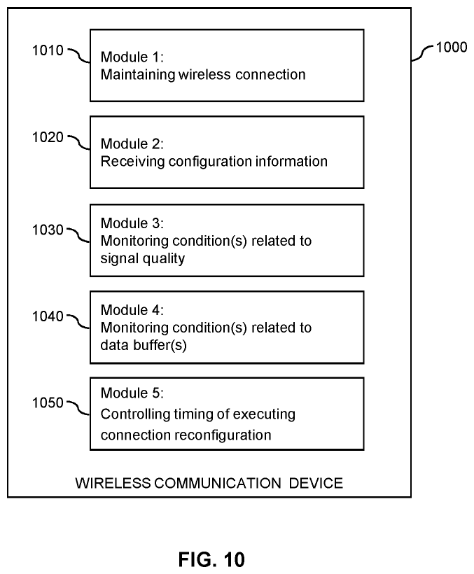

FIG. 10 shows a block diagram for illustrating functionalities of a wireless communication device 1000 which operates according to the method of FIG. 9. The wireless communication device 1000 may for example correspond to the above-mentioned UE 10 or to any of the above-mentioned access nodes 101-1, 101-2. As illustrated, the wireless communication device 1000 may be provided with a module 1010 configured to maintain a wireless connection, such as explained in connection with step 910. Further, the wireless communication device 1000 may be provided with a module 1020 configured to receive configuration information, such as explained in connection with step 920. Further, the wireless communication device 1000 may be provided with a module 1030 configured to monitor one or more conditions related to signal quality, such as explained in connection with step 930. Further, the wireless communication device 1000 may be provided with a module 1040 configured to monitor one or more conditions related to one or more data buffers, such as explained in connection with step 940. Further, the wireless communication device 1000 may be provided with a module 1050 configured to control the timing of executing reconfiguration of the wireless connection, such as explained in connection with step 950.

It is noted that the wireless communication device 1000 may include further modules for implementing other functionalities, such as known functionalities of a UE or of an access node of the 4G LTE technology or 5G NR technology. Further, it is noted that the modules of the wireless communication device 1000 do not necessarily represent a hardware structure of the wireless communication device 1000, but may also correspond to functional elements, e.g., implemented by hardware, software, or a combination thereof.

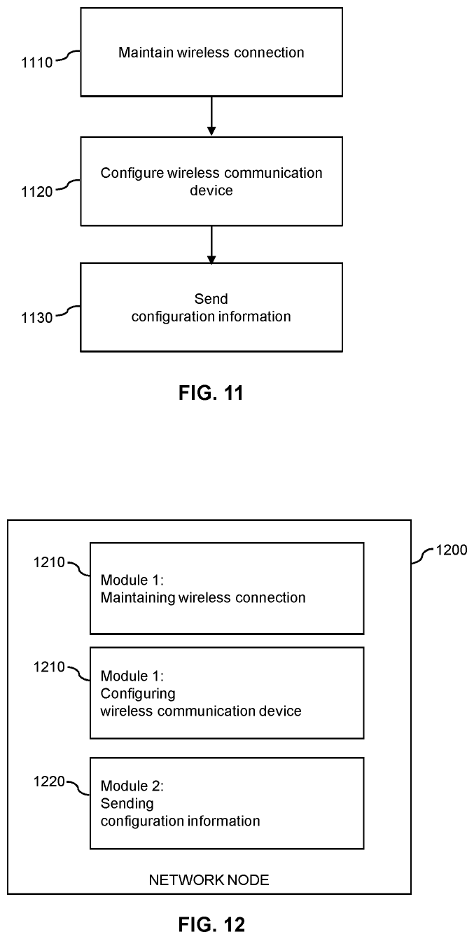

FIG. 11 shows a flowchart for illustrating a method, which may be utilized for implementing the illustrated concepts. The method of FIG. 11 may be used for implementing the illustrated concepts in a network node of a wireless communication network. The network node may for example correspond to any of the above-mentioned access nodes 101-1, 101-2 or to the above-mentioned control node 130.

If a processor-based implementation of the network node is used, at least some of the steps of the method of FIG. 11 may be performed and/or controlled by one or more processors of the network node. Such network node may also include a memory storing program code for implementing at least some of the below described functionalities or steps of the method of FIG. 11.

At step 1110, the network node may maintain a wireless connection to a wireless communication device. For example, the network node could be an access node of the wireless communication network, such as any one of the above-mentioned access nodes 101-1, 101-2 and maintain the wireless connection to a UE, such as the above-mentioned UE 10. In other scenarios, the network node could be a control node of the wireless communication network and be responsible for controlling and otherwise managing operation of wireless communication devices, such as any of the above-mentioned access nodes 101-1, 101-2 or the above-mentioned UE 10.

At step 1120 the network node configures a wireless communication device. The wireless communication device, such as any of the above-mentioned access nodes 101-1, 101-2 or the above-mentioned UE 10. In particular, the network node configures the wireless communication device to monitor one or more conditions related to one or more data buffers for data to be transmitted on a wireless connection maintained by the wireless communication device and, based on the one or more conditions, control timing of executing a reconfiguration of the wireless connection. In some cases, this wireless connection could correspond to the wireless connection maintained at step 910, e.g., if the network node is an access node and the configured wireless communication device is a UE to which the access node maintains the wireless connection.

The one or more data buffers may include a data buffer for data to be transmitted in an DL direction, such as the above-mentioned DL buffer(s). Alternatively or in addition, the one or more data buffers may include a data buffer for data to be transmitted in a UL direction, such as the above mentioned UL buffer(s). The one or more data buffers may for example be defined on a PDCP layer and/or on an RLC layer of a protocol stack of the wireless connection.

In some scenarios, the one or more conditions may include at least one condition which is based on determining when at least one of the one or more data buffers is empty. In some cases, such determination may be based on reports received by the wireless communication device, e.g., if the considered at least one data buffer is not maintained by the wireless communication device itself, but at a remote end of the wireless connection. In such cases, the network node may configure the wireless communication device to one or more reports indicating a status of the at least one data buffer and estimate based on the received one or more reports when the at least one of the one or more data buffers is empty. For example, if in CHO processes like illustrated in FIG. 2 the UE 10 controls triggering execution of the CHO based on the status of a DL buffer maintained by the serving AN 101-1, the UE 10 may be configured to determine from one or more reports from the serving AN 101-1 when the DL buffer is empty or will be empty. Similarly, if in network triggered HO processes like illustrated in FIG. 3 the serving access node 101-1 controls triggering execution of the HO based on the status of a UL buffer maintained by the UE 10, the serving AN 101-1 may be configured to determine from one or more reports from the serving UE 10 when the UL buffer is empty or will be empty.

Alternatively or in addition, network node may configure the wireless communication device to estimate based on a machine learning model when the at least one of the one or more data buffers is empty. For example, if in CHO processes like illustrated in FIG. 2 the UE 10 controls triggering execution of the CHO based on the status of a DL buffer maintained by the serving AN 101-1, the UE 10 may be configured to determine based on a machine learning model, such as the prediction model explained in connection with FIG. 7, when the DL buffer is empty or will be empty. Similarly, if in CHO processes like illustrated in FIG. 2 the UE 10 controls triggering execution of the CHO based on the status of a UL buffer maintained by the UE 10 itself, the UE 10 may be configured to predict based on a machine learning model, such as the prediction model explained in connection with FIG. 7, when the UL buffer will be empty. Further, if in network triggered HO processes like illustrated in FIG. 3 the serving access node 101-1 controls triggering execution of the HO based on the status of a DL buffer maintained by the serving AN 101-1, the serving AN 101-1 may be configured to determine based on a machine learning model, such as the prediction model explained in connection with FIG. 8, when the UL buffer is empty or will be empty. Further, if in network triggered HO processes like illustrated in FIG. 3 the serving access node 101-1 controls triggering execution of the HO based on the status of a DL buffer maintained by the serving AN 101-1, the serving AN 101-1 may be configured to predict based on a machine learning model, such as the prediction model explained in connection with FIG. 8, when the DL buffer will be empty.

In some scenarios, step 1120 may further involve that the network node configures the wireless communication device to monitor one or more conditions related to signal quality. For example, for purposes of controlling reconfiguration of the wireless connection in a handover from a source cell to a target cell or to one of multiple candidate target cells, the network node could configure the wireless communication device to monitor signal quality of the source cell and/or signal quality of the target cell e.g., in terms of RSRP; RSRQ, or SINR.

The reconfiguration may correspond to or be part of a RRC reconfiguration procedure, i.e., be based on RRC signaling to or from the wireless communication device.

In some scenarios, a target time for executing the reconfiguration may be based on at least one further condition. In such case, the controlling the timing of executing the reconfiguration may involve controlling whether to execute the reconfiguration after the target time, i.e., whether to delay the execution of the reconfiguration. The target time may for example be defined by the above-mentioned TTT. Accordingly, the at least one further condition may be related to signal quality of the wireless connection and/or to signal quality of multiple cells of the wireless communication network. For example, if the reconfiguration is a CHO or a HO, the at least one further condition may be based on a difference of signal quality between a source cell and a target cell of the CHO or HO. The target cell may be selected among multiple candidate target cells, e.g., based on the respective signal quality of each candidate target cell. More specifically, the at least one further condition could require that, the difference of signal quality between the source cell and the target cell exceeds a threshold plus a margin, and after that the difference of signal quality remains above the threshold until the target time.

In some scenarios, the reconfiguration may involve a handover of the wireless connection from a source cell to a target cell, such as the above-mentioned CHO processes as for example explained in connection with FIG. 2 or the above-mentioned HO processes as for example explained in connection with FIG. 3. In such cases, the controlling of the timing could also include selecting the target cell. For example, the target cell could be selected among multiple candidate target cells. This may be accomplished with the aim that the one or more conditions related to the data buffer are met when executing the handover to the selected target cell, such as in the example of FIG. 5.

If the reconfiguration of the wireless connection involves a handover of the wireless connection from a source cell to a target cell the one or more conditions may include at least one condition which is further related to signal quality of the target cell. In addition or as an alternative, the one or more conditions may include at least one condition which is further related to signal quality of the source cell.

In some scenarios, the reconfiguration may involve modification of a carrier aggregation configuration of the wireless connection, e.g., by removal or change of a component carrier.

In some scenarios, controlling the timing of executing the reconfiguration may involve triggering execution of the reconfiguration. For example, in CHO processes as explained in connection with FIG. 2 the UE 10 may trigger execution of the CHO if the condition(s) related to the data buffer and other required conditions are met. Similarly, in HO processes as explained in connection with FIG. 3 the serving access node 101-1 may trigger execution of the HO if the condition(s) related to the data buffer and other required conditions are met.

In some scenarios, controlling the timing of executing the reconfiguration may involve sending information for controlling execution of the reconfiguration. For example, in CHO processes as explained in connection with FIG. 2 the UE 10 may send reports concerning the considered data buffer(s) to the serving access node 101-1, and in response the serving access node 101-1 may adapt the scheduling of the UE 10 so that emptying of the data buffer is expedited and the CHO can be executed earlier. Further, in HO processes as explained in connection with FIG. 3 the serving access node 101-1 may control the timing by sending the HO command to the UE 10, e.g., by controlling when to send the HO command.

At step 1130, the network node may send configuration information to the wireless communication device. At least a part of the configuration information may have the purpose of configuring the wireless communication device as explained in connection with step 1120. In some cases, at least a part of the configuration information may be sent in a procedure for establishing the wireless connection, e.g., in an RRC connection setup procedure. In some cases, at least a part of the configuration information may be sent in a procedure for reconfiguration of the wireless connection, e.g., in an RRC connection reconfiguration procedure. In some cases, at least a part of the configuration information may be sent in a handover command, such as in the above-mentioned CHO command 207. For example, the configuration information could indicate the one or more conditions related to the one or more data buffers. Further, such configuration information could indicate additional parameters, e.g., timer values, threshold values, parameters of a machine learning model to be applied for making predictions concerning the one or more data buffers, and/or parameters of a machine learning model to be applied for making predictions concerning signal qualities related to the wireless connection.

FIG. 12 shows a block diagram for illustrating functionalities of a network node 1200 which operates according to the method of FIG. 11. The network node 1200 may for example correspond to any of the above-mentioned access nodes 101-1, 101-2 or to the above-mentioned control node. As illustrated, the network node 1200 may be provided with a module 1210 configured to maintain a wireless connection, such as explained in connection with step 1110. Further, the network node 1200 may be provided with a module 1120 configured to configure a wireless communication device with respect to controlling a timing of execution of reconfiguration of a wireless connection, such as explained in connection with step 1120. Further, the network node 1200 may be provided with a module 1230 configured to send configuration information, such as explained in connection with step 1130.

It is noted that the network node 1200 may include further modules for implementing other functionalities, such as known functionalities of an access node of the 4G LTE technology or 5G NR technology or of a control node used in such technology. Further, it is noted that the modules of the network node 1200 do not necessarily represent a hardware structure of the network node 1200, but may also correspond to functional elements, e.g., implemented by hardware, software, or a combination thereof.

It is noted that the functionalities as described in connection with FIGS. 11 and 12 could also be combined with the functionalities as described in connection with FIGS. 9 and 10, e.g., in a system that includes at least one wireless communication device operating according to the method of FIG. 9 and a network node operating according to the method of FIG. 11. The latter network node could then configure the wireless communication device to operate according to the method of FIG. 9.

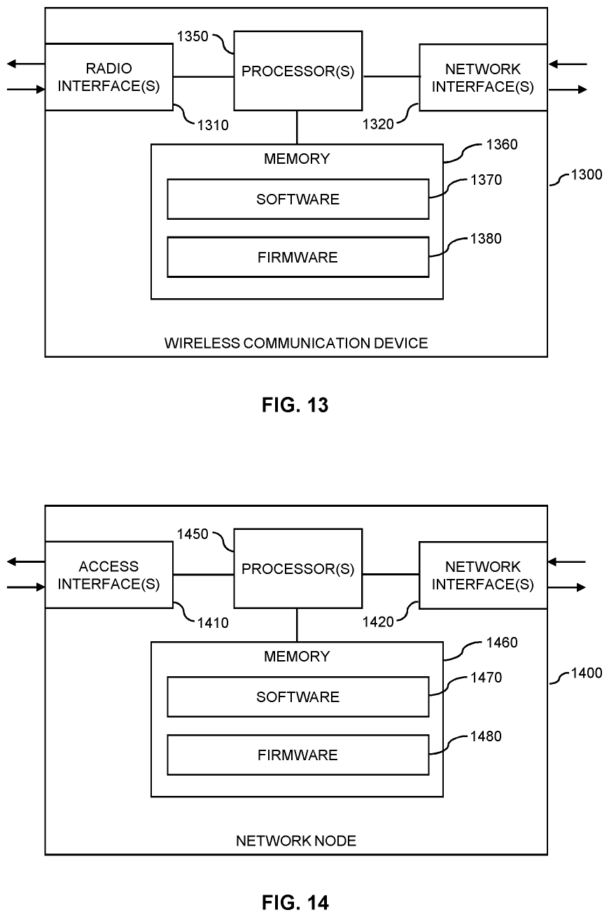

FIG. 13 illustrates a processor-based implementation of a wireless communication device 1000 which may be used for implementing the above-described concepts. For example, the structures as illustrated in FIG. 13 may be used for implementing the concepts in the above-mentioned UE 10 or any of the above-mentioned access nodes 101-1, 101-2.

As illustrated, the wireless communication device 1200 includes one or more radio interfaces 1210. The radio interface(s) 1210 may for example be used for maintaining a wireless connection, e.g., a wireless connection between an access node and a UE. The radio interface(s) 1110 may for example be based on the 4G LTE technology, the 5G NR technology, or a 6G technology. Further, the radio interface(s) 1110 may be used for sending or receiving configuration information and/or reports. Further, if the wireless communication device 1300 corresponds to an access node, it may include one or more network interfaces 1320. The network interface(s) 1320 may be used for communication with other nodes of the wireless communication network.

Further, the wireless communication device 1300 may include one or more processors 1350 coupled to the interface(s) 1310, 1320 and a memory 1360 coupled to the processor(s) 1350. By way of example, the interface(s) 1310, 1320, the processor(s) 1350, and the memory 1360 could be coupled by one or more internal bus systems of the wireless communication device 1300. The memory 1360 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1360 may include software 1370 and/or firmware 1380. The memory 1360 may include suitably configured program code to be executed by the processor(s) 1350 so as to implement the above-described functionalities for managing a wireless communication network, such as explained in connection with FIG. 9 or 10.

It is to be understood that the structures as illustrated in FIG. 13 are merely schematic and that the wireless communication device 1300 may actually include further components which, for the sake of clarity, have not been illustrated, e.g., further interfaces or further processors. Also, it is to be understood that the memory 1360 may include further program code for implementing known functionalities of a UE or access node. According to some embodiments, also a computer program may be provided for implementing functionalities of the wireless communication device 1300, e.g., in the form of a physical medium storing the program code and/or other data to be stored in the memory 1360 or by making the program code available for download or by streaming.

FIG. 14 illustrates a processor-based implementation of an network node 1400 which may be used for implementing the above-described concepts. For example, the structures as illustrated in FIG. 14 may be used for implementing the concepts in one of the above-mentioned access nodes 101-1, 101-2 or in the above-mentioned control node 130.

As illustrated, the network node 1400 may include one or more access interfaces 1410. If the network node 1400 corresponds to an access node, the access interface(s) 1410 may for example be used maintaining wireless connections to one or more UEs. The access interface(s) 1110 may for example be based on the 4G LTE technology, the 5G NR technology, or a 6G technology. Further, the access interface(s) 1410 may be used for sending configuration information to UEs, for sending reports to UEs, or for receiving reports from UEs. Further, the network node 1400 may include one or more network interfaces 1420. The network interface(s) 1420 may be used for communication with other nodes of the wireless communication network.

Further, the network node 1400 may include one or more processors 1450 coupled to the interface(s) 1410, 1420, and a memory 1460 coupled to the processor(s) 1450. By way of example, the interface(s) 1410, 1420, the processor(s) 1450, and the memory 1460 could be coupled by one or more internal bus systems of the access node 1400. The memory 1460 may include a ROM, e.g., a flash ROM, a RAM, e.g., a DRAM or SRAM, a mass storage, e.g., a hard disk or solid state disk, or the like. As illustrated, the memory 1460 may include software 1470 and/or firmware 1480. The memory 1460 may include suitably configured program code to be executed by the processor(s) 1450 so as to implement the above-described functionalities of an network node, such as explained in connection with FIG. 11.

It is to be understood that the structures as illustrated in FIG. 14 are merely schematic and that the network node 1400 may actually include further components which, for the sake of clarity, have not been illustrated, e.g., further interfaces or further processors. Also, it is to be understood that the memory 1460 may include further program code for implementing known functionalities of an access node of the 4G LTE technology or of the 5G NR technology or functionalities of a control node used in such technologies. According to some embodiments, also a computer program may be provided for implementing functionalities of the network node 1400, e.g., in the form of a physical medium storing the program code and/or other data to be stored in the memory 1460 or by making the program code available for download or by streaming.

As can be seen, the concepts as described above may be used for efficiently controlling reconfiguration of a wireless connection, with the aim of minimizing interruptions or outages caused by the reconfiguration, so that delays in transmission of data can be avoided to great extent. This may be of significant value, in particular for data related to real-time services and other time sensitive information.

It is to be understood that the examples and embodiments as explained above are merely illustrative and susceptible to various modifications. For example, the illustrated concepts may be applied in connection with various of wireless communication technologies, without limitation to the 4G LTE technology, 5G NR technology, or a 6G technology. Further, the illustrated concepts may be applied to various types of reconfiguration procedures, without limitation to handovers, changes in carrier aggregation configuration, or activation, deactivation, or modification of a DC configuration. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-50. (canceled)

51. A method of controlling connectivity to a wireless communication network, the method being performed by a user equipment connected to the wireless communication network and comprising:
the user equipment monitoring one or more conditions related to one or more data buffers for data to be transmitted on a wireless connection maintained by the user equipment; and
based on the one or more conditions, the user equipment controlling timing of executing a reconfiguration of the wireless connection;
wherein the one or more conditions comprise at least one condition which is based on determining when at least one of the one or more data buffers is empty.

52. The method according to claim 51, wherein the one or more data buffers comprise a data buffer for data to be transmitted in a downlink direction.

53. The method according to claim 51, wherein the one or more data buffers comprise a data buffer for data to be transmitted in an uplink direction.

54. The method according to claim 53, further comprising the user equipment estimating, based on a machine learning model, when the at least one of the one or more data buffers is empty.

55. The method according to claim 51, wherein a target time for executing the reconfiguration is based on at least one further condition, and wherein controlling the timing of executing the reconfiguration comprises whether to execute the reconfiguration after the target time.

56. The method according to claim 51, wherein a target time for executing the reconfiguration is based on at least one further condition, and wherein controlling the timing of executing the reconfiguration comprises whether to execute the reconfiguration before the target time.

57. The method according to claim 51, wherein the reconfiguration comprises a handover of the wireless connection from a source cell to a target cell.

58. The method according to claim 51, wherein the controlling the timing of executing the reconfiguration comprises selecting the target cell.

59. The method according to claim 51, wherein said controlling the timing of executing the reconfiguration comprises triggering execution of the reconfiguration.

60. The method according to claim 51, further comprising the user equipment receiving configuration information indicating at least one of the one or more conditions.

61. The method according to claim 51, further comprising the user equipment receiving configuration information for controlling the timing of executing the reconfiguration.

62. A method of controlling connectivity to a wireless communication network, the method comprising:
an access node of the wireless communication network configuring a user equipment to:
monitor one or more conditions related to one or more data buffers for data to be transmitted on a wireless connection maintained by the user equipment; and
based on the one or more conditions, control timing of executing a reconfiguration of the wireless connection;
wherein the one or more conditions comprise at least one condition which is based on determining when at least one of the one or more data buffers is empty.

63. The method according to claim 62, wherein the one or more data buffers comprise a data buffer for data to be transmitted in a downlink direction.

64. The method according to claim 62, wherein the one or more data buffers comprise a data buffer for data to be transmitted in an uplink direction.

65. The method according to claim 62, wherein a target time for executing the reconfiguration is based on at least one further condition, and wherein controlling the timing of executing the reconfiguration comprises deciding whether to execute the reconfiguration after the target time.

66. The method according to claim 62, wherein a target time for executing the reconfiguration is based on at least one further condition, and wherein controlling the timing of executing the reconfiguration comprises whether to execute the reconfiguration before the target time.

67. The method according to claim 60, further comprising the access node sending configuration information indicating at least one of the one or more conditions to the user equipment.

68. The method according to claim 60, further comprising the access node sending configuration information for controlling the timing of executing the reconfiguration to the user equipment.

69. A user equipment comprising:
at least one processor; and
a memory containing program code executable by the at least one processor, and whereby execution of the program code by the at least one processor causes the user equipment to:
monitor one or more conditions related to one or more data buffers for data to be transmitted on a wireless connection maintained by the wireless communication device; and
based on the one or more conditions, control timing of executing a reconfiguration of the wireless connection;
wherein the one or more conditions comprise at least one condition which is based on determining when at least one of the one or more data buffers is empty.

70. An access node for a wireless communication network, the access node comprising:
at least one processor, and
a memory containing program code executable by the at least one processor, and whereby execution of the program code by the at least one processor causes the access node to configure a user equipment to:
monitor one or more conditions related to one or more data buffers for data to be transmitted on a wireless connection maintained by the wireless communication device; and
based on the one or more conditions, control timing of executing a reconfiguration of the wireless connection;
wherein the one or more conditions comprise at least one condition which is based on determining when at least one of the one or more data buffers is empty.
